(19) United States
(12) Patent Application Publication
(10) Pub. No.: US 2010/0332981 A1
(43) Pub. Date: Dec. 30, 2010

(54) Providing Media Settings Discovery in a Media Processing Application

(76) Inventors: Daniel Lipton, Belmont, CA (US); Sheila A. Brady, Woodside, CA (US)

Correspondence Address: ADELI & TOLLEN, LLP, 11940 San Vicente Blvd., Suite 100, LOS ANGELES, CA, 90049, US

(21) Appl. No.: 12/495,800

(22) Filed: Jun. 30, 2009

(51) Int. Cl. G06F 3/00; G06F 3/048

(52) U.S. Cl. 715/716; 715/769

(57) ABSTRACT

Some embodiments provide a method for automatically identifying settings of a media file. The method initially receives the identification of a piece of media content. Media content includes sound and image data that can be stored as a media file. It then performs an automated process for discovering the media settings of the media file. Examples of settings that are automatically identified in some embodiments include video codec type, audio codec type, frame height and frame width, video bit rate, video frame rate, audio channels, etc. The method then stores the media settings that are discovered from the media file. The stored media settings are used subsequently in some embodiments to generate a media file.

### FIELD OF THE INVENTION

The present invention is directed towards automated techniques and tools for discovering settings of media content.

### BACKGROUND OF THE INVENTION

Digital graphic design, video editing, and media processing applications provide designers and artists with tools for generating and manipulating digital versions of sound and image media that can be presented or displayed using electronic devices. Examples of such applications include Final Cut Pro®, iMovie®, and Compressor®, sold by Apple Inc. Audio and video media files are generated from sound and image data by encoding the data. The audio and video media files are interpreted by a digital processor on an electronic device to produce sounds or images on an output device.

Sound and image data can be encoded into a media file using one of several file formats. A file format is typically distinguished by its codec. A codec has an encoding component that is used by a media processing application to encode sounds and images into digital data, and a decoding component that is used by a media player to decode the digital data back into sounds and images. Examples of formats include video formats such as MPEG-2 and H.264, and audio formats such as Advanced Audio Coding (AAC) and mp3. A container format can be used to organize video data and audio data together into a stream of coordinated video and audio data. For instance, a media file that is encoded in Apple Inc.'s QuickTime® (.mov) file format may contain a video track in the H.264 video format, and an audio track in the AAC audio format.

A media file has audio and video properties that reflect how the sound and image data is represented in the media file. Audio properties include the bit rate of the audio data, the number of channels in the audio data, etc. Video properties include image resolution, aspect ratio, data rate, frame rate, and key frame interval, etc. The properties may be modified to produce sounds and images with different properties.

When sound and image data is being encoded into a media file, a user needs to specify to a media processing application a file format and the properties that are desired for the media file. The file format and properties can be specified as a set of parameters and values that are read by the media processing application. These parameters and values are referred to as media settings.

A user may desire to generate a media file to have a format and properties that match the format and properties of another media file. In one prior approach, a user would first obtain format and properties information from the media file that needs to be matched. However, the user would first need to know how to obtain the format and properties information. For example, a user would need to know that some media players have an operation for revealing the format and some properties of a media file.

If a user is successful at obtaining the format and properties, the user would next translate the format and properties into a set of parameters and values that can be read by the media processing application. However, a user would also need to know how to arrange the parameters and values into a format that can be understood by the media processing application. For example, a user would need to know that some media processing applications have a settings creation interface for creating a set of media settings. Furthermore, the user would also need to know how to manually enter parameters and values into the settings creation interface to create media settings that are able to be parsed by a media processing application.

Therefore, there is a need in the art to allow a user to use a media processing application to generate a media file to have a format and properties that match the format and properties of another media file without requiring the user to have prior technical or operational knowledge for doing so.

### SUMMARY OF THE INVENTION

Some embodiments provide a method for automatically identifying settings of one or more pieces of media content. The method initially receives the identification of the media content, called “model media content” in some of the discussion below. It then performs an automated process for discovering the media settings of the media content. Examples of settings that are automatically identified in some embodiments include video codec type, audio codec type, frame height and frame width, video bit rate, video frame rate, audio channels, etc. The method then stores the media settings that are discovered from the media content. The stored media settings are used subsequently in some embodiments to generate another piece of media content (e.g., to encode another media file).

In some embodiments, the method is implemented in a media processing application. The media processing application provides one or more tools to allow a user to identify model media content. It also includes a settings discovery module that can automatically discover settings from the model media content. When the setting discovery module cannot identify one or more settings, this module in some embodiments specifies the default values for these settings. In some embodiments, the application also includes one or more tools that allow a user to modify the settings that are discovered or otherwise identified by the setting discovery module. The application further includes one or more data storage structures for storing the discovered, specified and/or modified settings. The application of some embodiments also includes a media generation tool that can generate new media content by using the discovered and/or stored settings of the model media content.

In some embodiments, the application tool that allows a user to identify the model media content includes a setting discovery area (e.g., setting discovery window) through which a user can specify the model media content. For instance, in some embodiments, this area can receive a representation of the model media content through a drag-and-drop operation (e.g., through a user's selection of an icon representing the media file and the user's drag of this icon to the setting discovery window). In conjunction or in lieu of this drag-and-drop capability, the setting-discovery area of some embodiments allows a user to identify the model media content through one or more search, navigate, and/or browse operations of the file storage structure.

The media processing application in some embodiments includes a module that monitors the setting discovery area to determine whether the application has received the identification of model media content. In some embodiments, the monitoring module employs a polling process to determine at regular intervals whether new content has been received at the setting discovery area. In other embodiments, the user-interface instructions that define the setting discovery area include a set of instructions that sends a message to the monitoring module to notify this module that an identification of model media content has been received. After the monitoring module determines that the identification of model media content is received at the setting discovery area, the monitoring module calls the settings discovery module to begin automatically discovering settings from the model media content. The settings discovery module stores the discovered settings, which as mentioned above can be used later by the media generation tool to generate a new media file.

In some embodiments, the media processing application also includes a settings display area (e.g., a setting display window) that can display the discovered settings of model media content. In some embodiments, the setting discovery area and the setting display area are the same area (e.g., are the same window). The settings display area of some embodiments also provides an interface that allows a user to modify the discovered settings. The media processing application of some embodiments also includes a settings discovery assistant that guides a user through one or more setting choices that are sequentially presented in one or more windows.

In some embodiments, the setting discovery tool of the media processing application is implemented in a command-line interface. For instance, the media processing application of some embodiments provides a settings discovery tool execution command for activating the settings discovery tool. The settings discovery tool execution command is submitted at the command-line interface with an identification of the model media content as an argument for the command. In response, the settings discovery tool discovers the settings and saves the discovered settings. As mentioned above, the saved settings can be later used in some embodiments to generate a new media file. In some embodiments, the media processing application also provides a settings listing command to list the discovered settings. The discovered settings may be opened at a command-line text editor for a user to modify the settings.

Several embodiments are described above by reference to a media processing application that can automatically discover settings of a piece of media content in order to allow a user to view, modify and store media content settings. However, one of ordinary skill will realize that the above-described techniques are used in other embodiments to automatically detect and present settings of other types of content (such as word processing files, database storage structures, software configuration files, etc.).

### BRIEF DESCRIPTION OF THE DRAWINGS

The novel features of the invention are set forth in the appended claims. However, for purpose of explanation, several embodiments of the invention are set forth in the following figures.

FIG. 1 illustrates four stages of a graphical user interface (GUI) of a media processing application with a settings discovery tool for discovering media settings from model media content, in accordance with some embodiments of the invention.

FIG. 2 illustrates a GUI at the stage when the settings discovery tool of a media processing application is activated for some embodiments of the invention.

FIG. 3 illustrates a GUI at the stage after discovered settings are created, presented, and are available to be used to generate a media file for some embodiments of the invention.

FIG. 4 illustrates a GUI at the stage when a settings discovery assistant is activated as implemented in some embodiments of the invention.

FIG. 5 illustrates a GUI when audio settings are inputted through the settings discovery assistant interface as implemented in some embodiments of the invention.

FIG. 6 illustrates an example of a GUI for displaying discovered media settings and for launching a settings discovery assistant as implemented in some embodiments of the invention.

FIG. 7 illustrates an example of a GUI for displaying and modifying discovered media settings of a QuickTime® file format as implemented in some embodiments of the invention.

FIG. 8 illustrates an example of a GUI for displaying and modifying the video discovered settings of a QuickTime® file format as implemented in some embodiments of the invention.

FIG. 9 illustrates an example of a GUI for displaying and modifying the video discovered settings of a QuickTime® file format as implemented in some embodiments of the invention.

FIG. 10 illustrates an example of a GUI for displaying and modifying the video discovered settings of a MPEG-2 file format as implemented in some embodiments of the invention.

FIG. 11 illustrates an example of a GUI for displaying and modifying frame controls settings as implemented in some embodiments of the invention.

FIG. 12 illustrates an example of a GUI for selecting, viewing and modifying audio and video filters as implemented in some embodiments of the invention.

FIG. 13 illustrates an example of a GUI for displaying and modifying the geometry discovered settings of any file format as implemented in some embodiments of the invention.

FIG. 14 illustrates an example of a conceptual machine-executed process for discovering media settings from a model media file, and generating another media file using the media settings that were discovered from the model media file as implemented in some embodiments of the invention.

FIG. 15 illustrates an example of a conceptual machine-executed process for discovering media settings from a model media file as implemented in some embodiments of the invention.

FIG. 16 illustrates an example of a conceptual machine-executed process for analyzing a model media file to discover media settings as implemented in some embodiments of the invention.

FIG. 17 illustrates an example of a conceptual machine-executed process for converting a media file using the discovered media settings as implemented in some embodiments of the invention.

FIG. 18 illustrates an example of a conceptual machine-executed process for discovering certain format-specific settings as implemented in some embodiments of the invention.

FIG. 19 illustrates an example of a conceptual machine-executed process for discovering a data rate from computed properties as implemented in some embodiments of the invention.

FIG. 20 conceptually illustrates the software architecture of a media processing application and computer operating system as implemented in some embodiments of the invention.

FIG. 21 conceptually illustrates the software architecture of a settings discovery tool as implemented in some embodiments of the invention.

FIG. 22 conceptually illustrates the data flow into and out of the media conversion tool as implemented in some embodiments of the invention.

FIG. 23 conceptually illustrates a process of some embodiments for defining and storing a media-editing application of some embodiments.

FIG. 24 illustrates a computer system with which some embodiments of the invention are implemented.

### DETAILED DESCRIPTION OF THE INVENTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for automatically identifying settings of one or more pieces of media content. The method initially receives the identification of the media content. It then performs an automated process for discovering the media settings of the media content. Examples of settings that are automatically identified in some embodiments include video codec type, audio codec type, frame height and frame width, video bit rate, video frame rate, audio channels, etc. The method then stores the media settings that are discovered from the media content. The stored media settings are used subsequently in some embodiments to generate another piece of media content (e.g., to encode another media file).

In some embodiments, the method is implemented in a media processing application. The media processing application provides one or more tools to allow a user to identify model media content. It also includes a settings discovery module that can automatically discover settings from the model media content. When the setting discovery module cannot identify one or more settings, this module in some embodiments specifies the default values for these settings. In some embodiments, the application also includes one or more tools that allow a user to modify the settings that are discovered or otherwise identified by the setting discovery module. The application further includes one or more data storage structures for storing the discovered, specified and/or modified settings. The application of some embodiments also includes a media generation tool that can generate new media content by using the discovered and/or stored settings of the model media content.

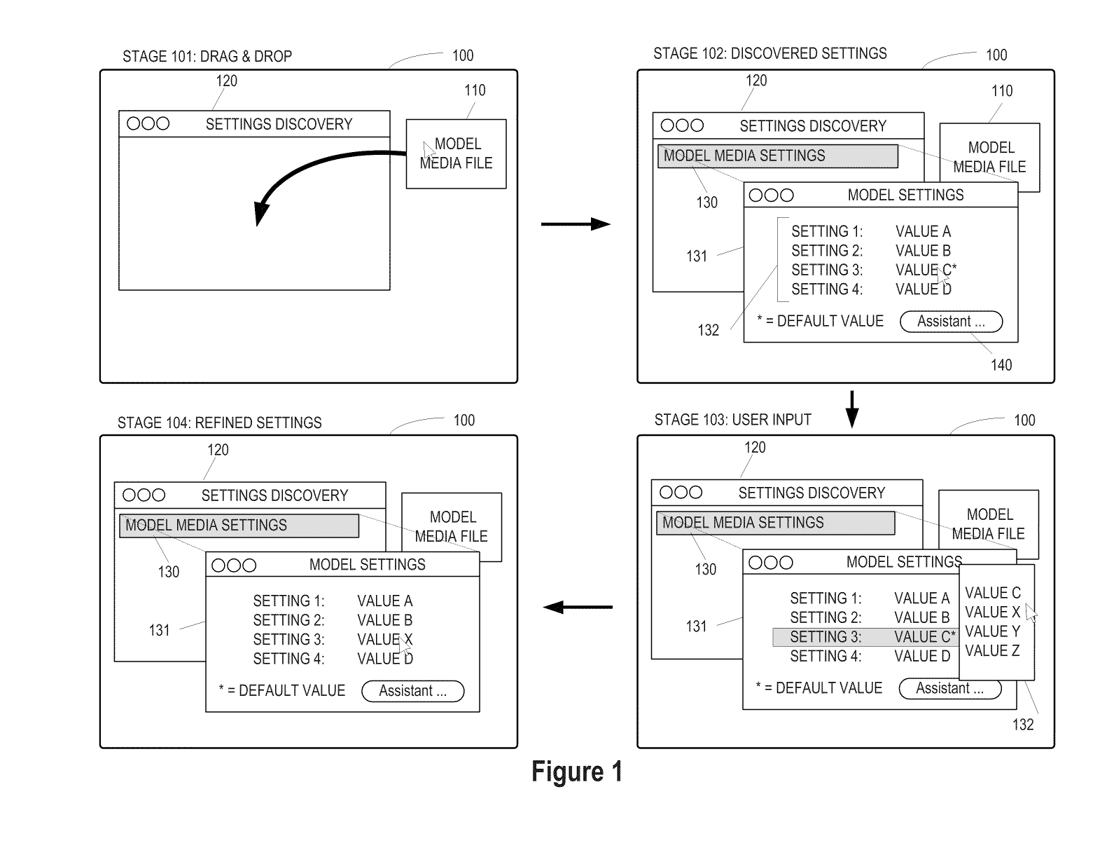

FIG. 1 illustrates a graphical user interface (GUI) 100 of one such media processing application of some embodiments of the invention. The GUI 100 includes a setting discovery window 120 that can receive an icon that represents a piece of model content through a drag-and-drop operation. The reception of such an icon causes a setting discovery module of the media processing application to discover in an automated manner several media settings of the model media content.

FIG. 1 illustrates the GUI 100 at four different stages. As shown in this figure, the first stage 101 involves a user's selection of model media file 110 that stores model media content, and the user's drag of this file to the settings discovery window 120. In some embodiments, the model media file 110 can include any combination of sound and image data. Sound data includes music, sound effects, audio data synchronized to accompany video data, or other types of audio data. Image data includes photographs, images, video, slideshows, or other types of visual data. In some embodiments, the sound and image data are digital data that can be processed by a digital processing unit to produce sounds and images on an output device. For each type of data, the model media content typically has several properties and values associated with these properties. Examples of sound properties include the audio encoding format, the number of audio channels, etc. Examples of image properties include the video encoding format, video dimensions (e.g., the width and height of the image sequence), aspect ratio, frame rate, etc.

The first stage 101 illustrates the drag-and-drop of the model media file 110 onto the settings discovery window 120. This operation activates a settings discovery tool module. Upon activation, the settings discovery module discovers the model media settings of the model media content. The second stage 102 of the FIG. 1 illustrates the GUI 100 as displaying a model settings window 131 that presents the settings and values 132 of the model media file 110 for user review. As shown in FIG. 1, settings and values 132 includes Settings 1 to 4, and corresponding values A, B, C, and D.

To discover the model media settings 130, the settings discovery tool of some embodiments analyzes the file's data to discover the file's format and properties. The file's format and properties are extrapolated into specific settings parameters and values that can be used by a media generation tool to generate another media file.

The setting discovery tool of some embodiments uses different techniques to identify different properties of model media file 1 10. Discovery techniques include reading and copying some properties from metadata notations and computing some properties from data measurements and data patterns. In some embodiments, some or all of the properties that are notated in metadata, or notated in a data structure within model media file 110, are read by the settings discovery tool, and copied directly as values for the corresponding settings parameters. For example, QuickTime movie files notate certain media properties in a data structure called a movie resource. The movie resource includes information such as a listing of each of the component audio and video tracks included in the QuickTime movie file, the compression types of the audio and video tracks, frame offset information, and timing information. Other examples of properties and values notated in metadata include frame width and height in pixels, the video and audio codec of the model media content, and the number of channels in the audio data.

Some properties that are not notated in any metadata or data structures in the model media content. The setting discovery tool identifies some such properties by computing them through an analysis of the sound and image content of the media file. The analysis includes taking certain measurements of the data sequence of the media file and performing calculations with the measurements. For example, in some embodiments, a data rate setting is computed by determining the size of a data sequence (in bits), determining the duration of the data sequence (in seconds), and dividing the size by the duration to determine a data rate (in bits per second). In some embodiments, a data rate is determined for only a portion of the data sequence, and is extrapolated for the entire data sequence for the data file. A frame rate can be similarly computed by determining the number of frames per duration of a data sequence. Other properties that can be computed include video properties such as key frame interval, aspect ratio, and image resolution.

Other properties, such as whether model media content was previously re-timed to change its framerate (e.g., by a 3:2 pulldown operation), can be determined by examining the data sequence for patterns in the data. For example, in a 3:2 pulldown operation, the frame rate of video data that was originally recorded in 24 frames per second (fps) is converted to a frame rate of 30 fps by repeating certain frames in a specified pattern. If model media content had undergone a 3:2 pulldown operation, such a specified pattern is observable from the data sequence. For some embodiments, the observation that the model media content was previously re-timed is extrapolated into a setting that, when used to convert another media file that has a frame rate of 24 fps from one version to another version, instructs the media generation tool perform the re-timing operation.

For other properties that are neither notated in any metadata or data structures, nor computable from any measurements taken from the data sequence, the settings discovery tool of some embodiments provides default values for such properties. An example of such a non-discoverable property includes whether the model media content was previously color corrected. As conceptually shown in stage 102, Property 3 is a non-discoverable property. Accordingly, a default value, Value C, is selected for Setting 3. An asterisk (*) is displayed next to Value C to indicate that Value C is a default value, in contrast with an automatically-discovered value.

As mentioned above, the GUI 100 in the second stage 102 displays a model settings window 131 that presents the settings and values 132 for user review. Through the model setting window 131, the user can modify settings that are discovered or specified to default values by the media processing application. The third stage 103 of the FIG. 1 illustrates an example of a user modifying the settings and values 132 after having reviewed the settings and values 132 in the model setting window 131. Specifically, in the third stage 103, the model settings window 131 presents a menu 132 with several selectable values for Setting 3. Such a menu may also be presented for modifying values for the other settings. In the third stage 103, any of the values in the menu 132 can be selected for modifying Setting 3. In the example illustrated in FIG. 1, the user selects the Value X to replace Value C for Setting 3, as illustrated in the fourth stage 104 of this figure.

In addition to allowing a user to modify the discovered or default-specified setting through the model setting window, the GUI 100 provides another tool for modifying and refining the settings values. This other tool is a setting assistant tool that can be activated through an assistant tool UI item 140, which is conceptually illustrated in the second, third and fourth stages 102, 103, and 104 of FIG. 1. As shown in these stages, this assistant tool UI item in some embodiments can be a button that is displayed in the model setting window 131. In other embodiments, this UI item can be button or other selectable UI item that is displayed in other parts of the GUI. In still other embodiments, the assistant UI item 140 represents a keystroke operation that can be used to activate the setting assistant tool. Also, in some other embodiments, the media processing application activates the assistant tool without any request from the user (e.g., for the example illustrated in FIG. 1, the application activated the assistant tool immediately after second stage 102 in some embodiments).

Instead of directly modifying the setting values through fields or selectable values that are presented in the model setting window 131, a user can interact with the activated assistant tool in order to make one or more setting choices that are sequentially presented by the assistant tool in one or more windows. In other words, the assistant tool in some embodiments assists the user in selecting values for any of the settings by identifying settings with default values, providing technical descriptions of the settings, and guiding the user through other settings options. In other embodiments, the assistant tool not only guides the user through choices that allow the user to specify values for default-set parameters, but also guides the user through choices that allow the user to modify some of the auto-discovered settings of the model media content. The assistant tool will be described in more detailed below.

After the auto-discovering the settings and providing a user with an opportunity to specify and/or modify settings, the media processing application stores the model media settings 130. This application uses different techniques to store model media settings 130 in different embodiments. For some embodiments, model media settings 130 may be stored as a set of data records within a data structure maintained by the media processing application. For some embodiments, the set of data records are stored as a data file that is accessible by the media processing application. The stored model media settings 130 are available to the media generation tool of the media processing application to generate other media files to have properties based on model media file 110.

The example illustrated in FIG. 1 describes a media processing application that can automatically discover settings of a piece of media content in order to allow a user to view, modify and store media content settings. However, one of ordinary skill will realize that the above-described techniques are used in other embodiments to automatically detect and present settings of other types of content (such as word processing files, database storage structures, software configuration files, etc.).

The example illustrated in FIG. 1 shows one possible implementation for a settings discovery tool for discovering settings from model media content. One of ordinary skill will realize that many other possible implementations exist. For instance, in some embodiments, the settings discovery tool is implemented using a command-line interface. The command-line interface provides a set of commands that activates and provides input to the settings discovery tool. For instance, model media file 110 is identified for the settings discovery tool by submitting the model media content's filename as an argument for the command. In another example, the setting-discovery area of some embodiments allows a user to identify the model media content through one or more search, navigate, and/or browse operations of the file storage structure.

A media processing application with a settings discovery tool for discovering media settings from model media content provides the advantage of allowing any user to produce a set of media settings that matches the format and properties of model media content without needing technical understanding of the format and properties. The refinement features, as described with reference to third stage 103 and fourth stage 104, allow advanced users with technical understanding of the format and properties to customize and refine the automatically discovered settings. The assistant tool, which is activated via the assistant tool UI button 140, provides guided steps to allow average users to use the refinement features to customize and refine the automatically discovered settings.

Several more detailed embodiments of the invention are described in the sections below. In the examples below, the detailed embodiments are described by reference to media content that is stored as a file. However, one of ordinary skill in the art will realize that the features of the invention can be used in other embodiments with media content that is stored in other types of structures, including as binary large objects (BLOBs), database objects, other data storage formats.

In the examples below, the QuickTime® file format is the file format used to show many of the features of the invention. However, one of ordinary skill in the art will realize that the features of the invention can be used with other file formats, including video formats such as MPEG-2, H.264 and Windows Media Video (WMV), audio formats such as Advanced Audio Coding (AAC), MP3, and Windows Media Audio (WMA), and other container formats such as Audio Video Interleave (AVI).

Furthermore, in the examples below, the settings discovery tool and media generation tool are implemented as part of a media conversion application, such as Compressor®, sold by Apple Inc. However, the settings discovery tool and the media generation tool may be implemented as part of different media processing applications. For example, the settings discovery tool and the media generation tool may be included in a media compositing application such as Final Cut Pro® and iMovie®, also sold by Apple Inc. For some embodiments, the settings discovery tool and the media generation tool may be implemented on electronic devices. For example, the settings discovery tool or the media generation tool may be included in the firmware of a video camera device. In these embodiments, as the video camera receives video data that is captured by an image sensor (e.g., a charge-coupled device, or CCD, image sensor), the video camera encodes the video data into a media file using a set of discovered settings that are discovered by a settings discovery tool on the video camera device.

Section I describes some embodiments of the invention that provide a settings discovery tool for discovering media settings from a model media file, and a media generation tool for generating another media file using the media settings that were discovered from the model media file. Section II describes examples of conceptual machine-executed processes of the settings discovery tool and the media generation tool for some embodiments of the invention. Section III describes several examples of the software architecture used to implement by some embodiments of the invention. Section VI describes a process for defining a media processing application of some embodiments. Finally, Section V describes a computer system and components with which some embodiments of the invention are implemented.

I. Media Setting Discovery

As discussed above, several embodiments provide a media processing application for generating a media file based on a set of media settings. The media processing application of some embodiments provides: (1) a settings discovery tool for discovering media settings from a model media file, and (2) a media generation tool for generating a digital media file using the media settings that were discovered from the model media file.

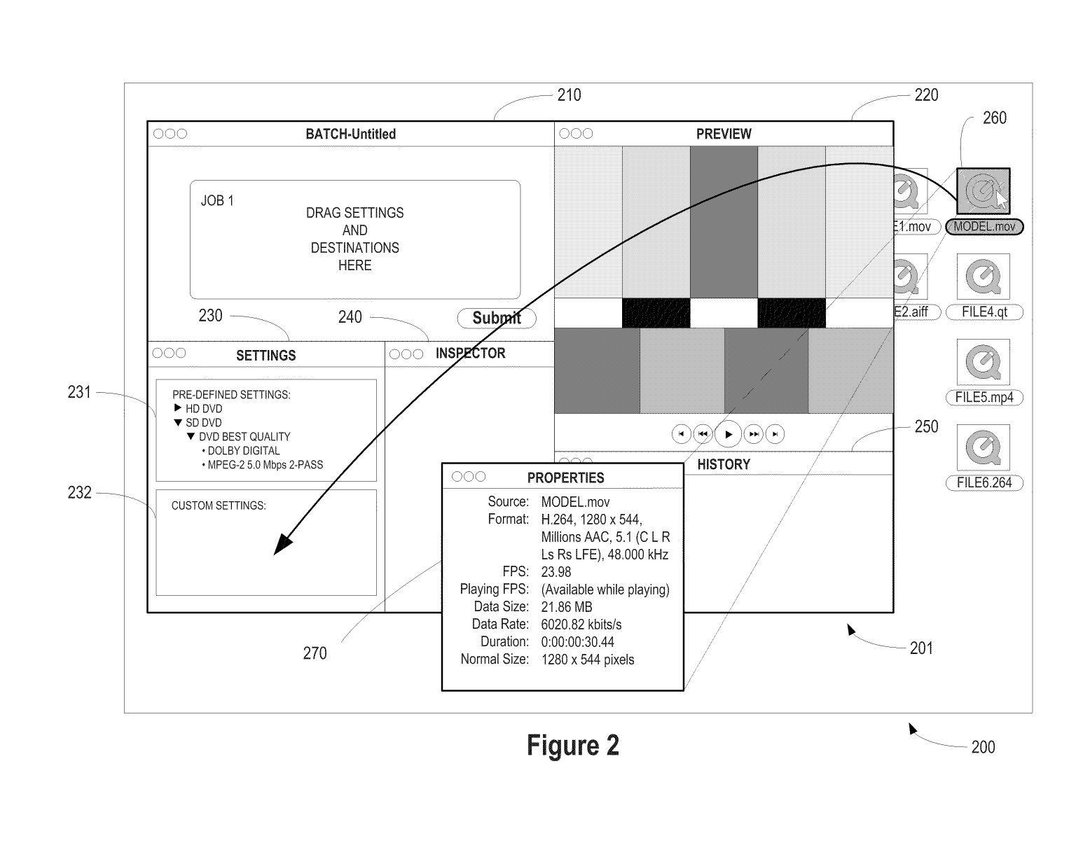

The following discussion will describe in more detail some embodiments of the settings discovery tool and media conversion tool with reference to FIGS. 2-13.

A. Settings Discovery Tool and Media Generation Tool

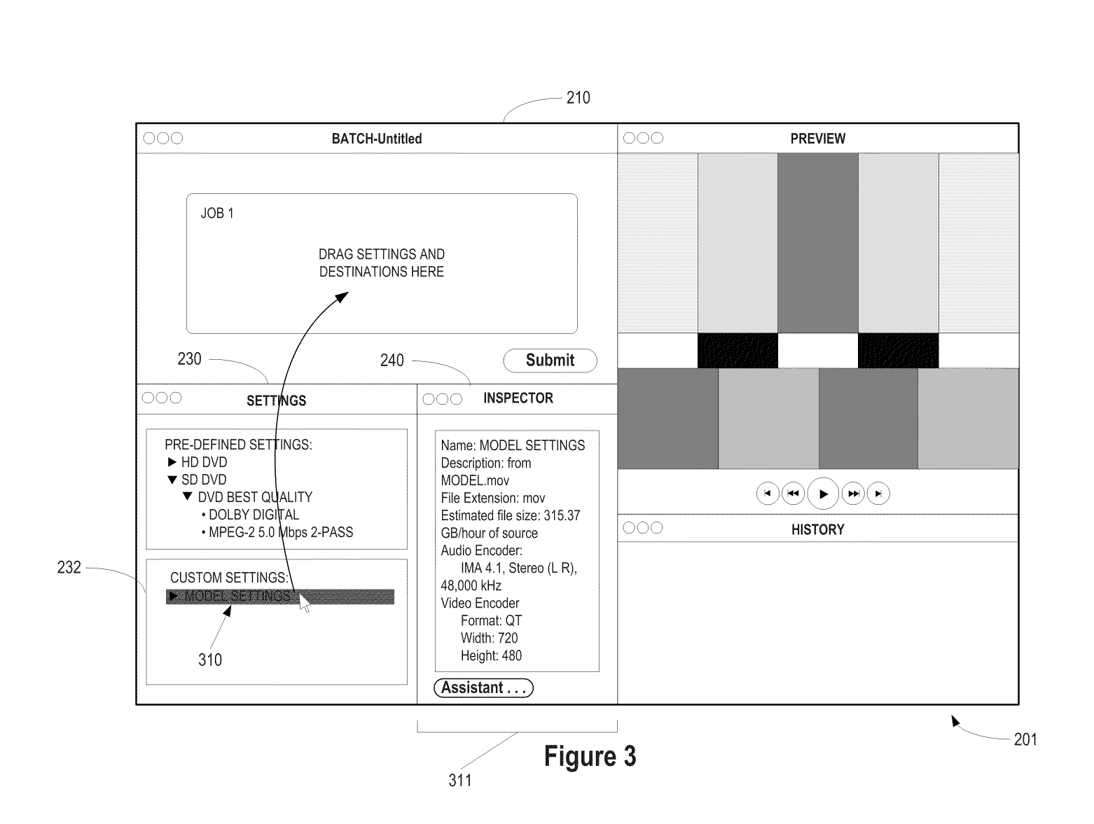

FIGS. 2-3 illustrate several stages of a user's interaction with graphical user interface (GUI) 201 of a media processing application. The media processing application in the example illustrated in FIGS. 2-3 includes a settings discovery tool for discovering media settings from a model media file, and a media generation tool for generating a new media file from a set of media data using the discovered media settings. In this particular example shown in FIGS. 2-3, the media generation tool generates a new media file by converting the set of media data using the discovered settings. Media data describes any data that represents sounds and/or images, including data produced from a media editing application, such as Apple's Final Cut Pro® or iMovie®, data produced from an electronic image sensor on a video camera, such as a CCD sensor, or data from a media file encoded with a particular codec, such as a QuickTime movie media file. In addition to using the discovered settings to generate a new media file, the settings can be used at the time a media compositing project is created. Specifically, a media compositing application can use the discovered settings to specify settings for the project before any media data is provided for the project.

GUI 201 includes five main windows: batch window 210, preview window 220, settings window 230, inspector window 240, and history window 250. Settings window 230 includes a pre-defined settings interface 231 and custom settings interface 232. FIG. 2 also shows an icon 260 that identifies a QuickTime movie model media file. The icon 260 is dragged-and-dropped into the customs settings interface 232 of settings window 230 as input for the settings discovery tool to activate settings discovery from the QuickTime movie.

Batch window 210 is a submission window for submitting conversion requests to a media generation tool. A conversion request is also known as a job. Multiple jobs are known as a batch of jobs. A job requires three inputs: media data, a set of settings, and a destination to store the converted version of the media file.

Preview window 220 is for reviewing the media data, and for previewing a version of the new media file based on the media data and the settings before the actual conversion occurs. The preview is thus a simulation of certain aspects of the conversion, such as the application of filters, and only reflects a limited sample of the properties specified by the media settings.

Settings window 230 is for browsing and creating settings. The settings are selectable as input for a conversion request. The settings are also selectable for inspection and modification. Pre-defined settings interface 231 shows typical media settings for some output formats. In the example shown in FIG. 2, pre-defined settings include various settings for creating high-definition DVDs, and various settings for creating standard-definition DVDs.

Custom settings interface 232 displays user-defined media settings. User-defined settings may include saved sets of pre-defined settings that have been modified by the user, sets of settings that users have originally created through a settings creation interface of the media processing application, and sets of discovered settings discovered by the settings discovery tool.

Custom settings interface 232 is also an active GUI into which an icon 260 can be graphically dragged and dropped to invoke the settings discovery tool. The model media file identified by icon 260 is has a set of properties, some of which are listed in properties window 270. The properties listed in properties window 270 are conceptually shown in FIG. 2 as explicitly notated parameter/value pairs in a data structure. However, as previously discussed, some properties are actually not notated in any metadata or data structures, or not computable from any measurements taken from the data sequence.

The media processing application in some embodiments includes a monitoring module that monitors the custom settings interface 232 to determine whether the application has received the identification of a model media file. In some embodiments, the monitoring module employs a polling process to determine at regular intervals whether new content has been received at the custom settings interface 232. In other embodiments, the user-interface instructions that define the custom settings interface 232 include a set of instructions that sends a message to the monitoring module to notify this module that an identification of a model media file has been received. After the monitoring module determines that the identification of a model media file is received at the custom settings interface 232, the monitoring module calls the settings discovery tool to begin automatically discovering settings from the model media file.

Inspector window 240 is for presenting attributes of any selected object in GUI 201. As shown in FIG. 2, inspector window 240 does not display anything because there is no object selected. As further described below, when a set of media settings is selected, inspector window 240 presents the individual parameters and values of the media settings. Inspector window 240 is also an interface for manually modifying any individual setting in a set of media settings.

History window 250 provides access to, and some information about, previously submitted media generation requests. History 250 provides an interface for pausing a media generation operation, for resubmitting previously submitted media generation requests by dragging an entry from history window 250 to batch window 210. History 250 also displays submission details about particular media generation requests, and the location of the converted media files from previously submitted media generation requests. History window 250 also provides a progress bar for displaying the status of previously submitted media generation requests.

FIG. 3 illustrates GUI 201 of the media processing application in the stage after model media file 260 has been dropped into custom settings interface 232 to invoke the settings discovery tool, and after the settings discovery tool has saved a discovered a set of compressions settings in custom settings 232. In addition to the five windows discussed with reference to FIG. 2, FIG. 3 also displays GUI 201 with model media settings 310, and inspector window 240 with a summary view 311 of the parameters and values that form model media settings 310.

Selectable UI item 310, as illustrated in FIG. 3, provides access to the discovered model media settings. When UI item 310 is selected, as shown in FIG. 3 by the highlighting of the text, inspector window 240 presents the individual settings of model media settings 310, shown in FIG. 3 as summary view 311. Inspector window 240 provides other views that display the settings in separate categories. As further described below, the other views in inspector window 240 also provide an interface for manually editing the settings.

The following describes the operation of a media processing application by reference to FIGS. 2-3 for some embodiments of the invention. As shown in FIG. 2, a user selects an icon 260 for dragging and dropping into custom settings interface 232. When the custom settings interface 232 receives icon 260 as input, the media conversion tool of the media processing application invokes the settings discovery tool to discover settings from model media file 260. For some embodiments, as described above, the discovered settings are extrapolated from metadata, from measurements taken from the data sequence, or from requested user input. The discovered settings stored as a set of data records within a data structure maintained by the media processing application, or as a data file that is accessible by the media processing application.

Next, as shown in FIG. 3, the custom settings interface 232 displays a selectable UI item 310 that identifies the discovered model media settings. The model media settings are selected by a mouse-click or similar input at UI item 310 of custom settings interface 232. The media processing application displays the selected settings in inspector window 240.

Finally, model media settings are identified for a conversion request by dragging and dropping UI item 310 into batch window 210. UI item 310, along with other input, such an identification of a set of media data and other required data, are submitted to a media generation tool that generates a new media file using model media settings.

B. Settings Discovery Assistant

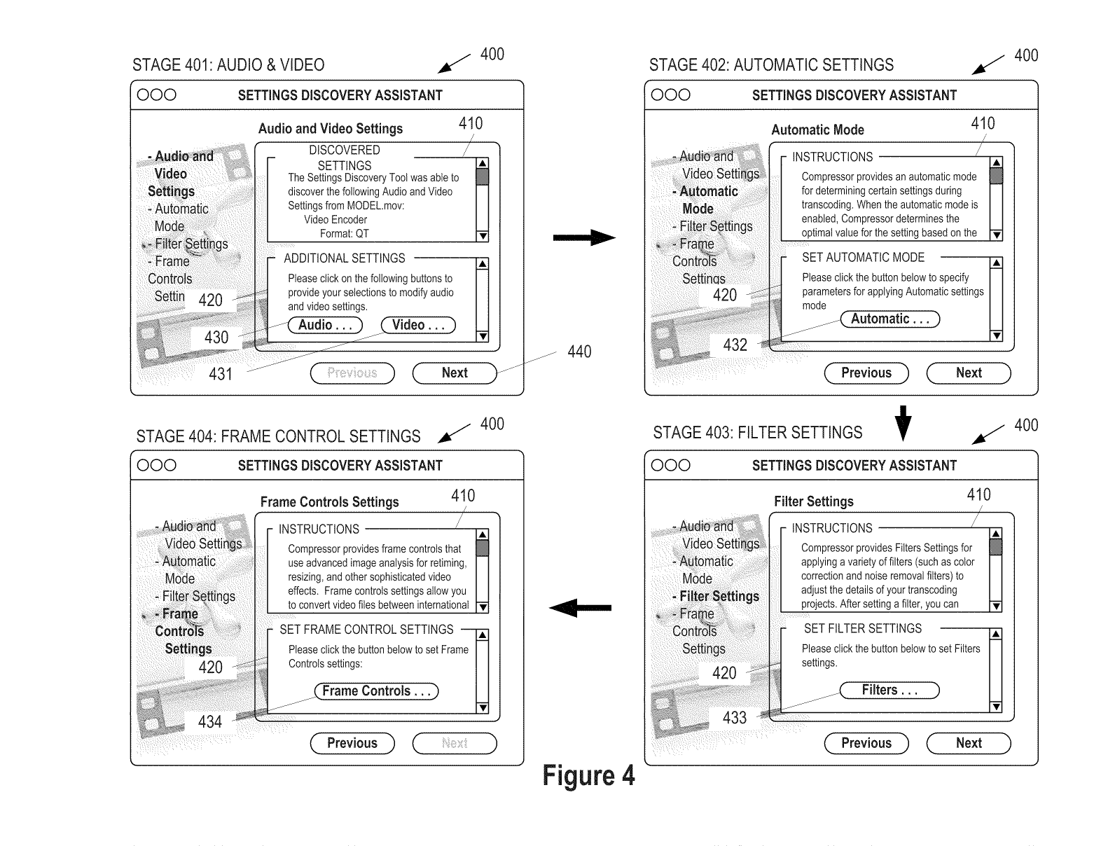

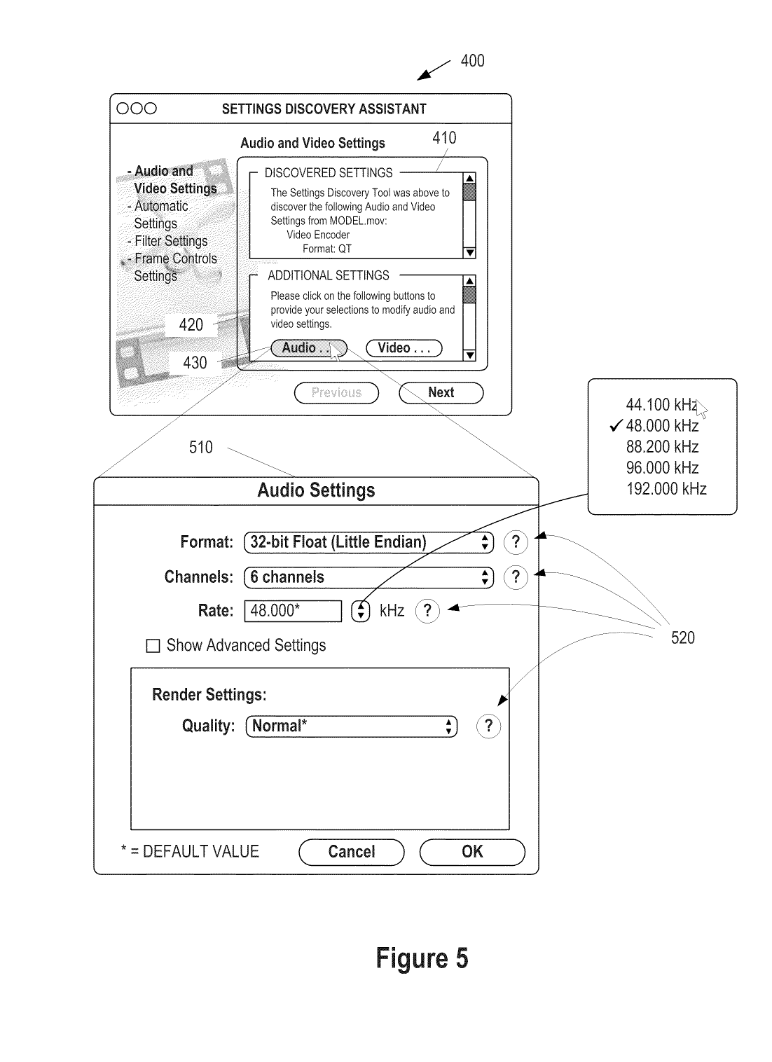

In some embodiments of the invention, the settings discovery tool provides a settings discovery assistant for assisting users in entering or modifying settings that are not automatically discoverable by the settings discovery tool. FIGS. 4-5 illustrate a GUI 400 of the settings discovery assistant. The settings discovery assistant provides assistance to users for entering or modifying: (1) audio and video settings; (2) automatic settings; (3) filter settings; and (4) frame controls settings. For some embodiments of the invention, a settings discovery assistant is launched by the settings discovery tool after the settings discovery tool completes discovery of any settings that are notated in metadata or data structures, or are computed from measurements taken of the data sequence. In some embodiments, the settings discovery assistant is initiated for a particular set of defined settings when a launch command is received from a user.

In the example shown in FIG. 4, the settings discovery assistant provides a series of dialog windows 400 that include information pane 410 and settings access pane 420. For some categories of settings, information pane 410 provides the user with a listing of the current values for each setting, including asterisks (*) to point out which of the values are default values for non-discoverable settings. The settings discovery assistant provides customized guidelines for selecting values for those settings. Settings access pane 420 provides UI buttons that give the user access to particular settings selection interfaces.

At stage 401, a dialog window 400 provides assistance for setting Audio and Video Settings. Information pane 410 presents a report to the user regarding the state of the discovered settings. In particular, the discovered settings report informs the user as to which Audio and Video settings were successfully determined from the model media file. The discovered settings report also informs the user regarding which settings parameters were set with default values, and informs the user that the default values may be modified. Settings access pane 420 provides Audio button 430 or Video button 431 to access Audio and Video settings, respectively, for modification. Receiving input from Next button 440 at any time causes the settings discovery assistant to advance to the next stage.

At stage 402, dialog window 400 provides assistance for overriding the explicit values entered or discovered for certain settings with an automatic mode. Instead of being set with explicit values, an automatic mode can be selected for some settings. A setting in the automatic mode causes the setting to be automatically selected at the time of conversion by the settings conversion module based on the properties of the media file that is being converted. For instance, for the Aspect Ratio setting, instead of selecting an explicit value such as “4:3” or “16:9,” the automatic mode would set the Aspect Ratio setting at the time of conversion to match the Aspect Ratio of the source file being converted. At stage 402, information pane 410 provides instructions to assist the user in deciding whether to apply the automatic mode to any particular setting. Settings access pane 420 provides Automatic button 432 to access an automatic mode settings selection interface.

At stage 403, dialog window 400 provides assistance for using Filter Settings. Information pane 410 provides instructions to assist the user in selecting filters for the settings. Settings access pane 420 provides a Filters button 433 to access a filters settings selection interface. Filters refer to a wide range of operations that edit video or audio content by applying treatments to each frame of a video sequence, or to an audio sequence. Filters are available for video editing operations such color correction, gamma correction, deinterlacing, brightness and contrast, and text overlay, and audio editing operations such as dynamic range adjustments and frequency shaping. Whether such filter settings were previously used in encoding the model media file is not discoverable from the model media file because filters generally modify a model media file without notating the difference between the old version and the new version in the media file. Accordingly, the settings discovery tool, by default, assigns an Off value to all filters when producing a set of model media settings.

At stage 404, dialog window 400 provides assistance for setting Frame Control Settings. Information pane 410 provides instructions to assist the user in selecting frame controls for the settings. Settings access pane 420 provides a Frame Controls button 434 for accessing a frame controls settings selection interface. Frame controls are used to convert video files between international television standards such as PAL to NTSC, or NTSC to PAL, to downconvert high definition (HD) video sources to standard definition (SD), or upconvert SD to HD, to convert a progressive stream to an interlaced one, or interlaced to progressive, and to perform high-quality frame rate adjustments, including high-quality slow-motion effects. Frame controls can also be used to automatically remove 3:2 pull-down from a video sequence.

An audio settings selection interface that is accessible from the GUI 400 at stage 401 will be described below by reference to FIG. 5. FIG. 5 illustrates an audio settings selection interface 510 that is accessible through Audio button 430 of the settings access pane 420. The audio settings selection interface 510 may show different parameters depending on the file format that is discovered for the model media settings in general. In the example shown, the audio settings selection interface 510 has selectable parameters for format, channels, sample rate, and render quality. The sample rate and the render quality were not automatically discoverable, and have default values selected by the settings discovery tool, as indicated by the asterisk (*) shown next to the selected value. Audio settings selections interface also provides access to additional information about each of the parameters through information buttons 520.

While the example of a setting discovery assistant as illustrated in FIGS. 4-5 has been described with reference to certain features and actions, one of ordinary skill in the art will recognize that the process may be implemented using other specific embodiments without departing from the spirit of the invention. For instance, the settings discovery assistant may be implemented with a command-line interface, or with a GUI that is differently configured than in the example described. In addition, some potential operations have been omitted for clarity. For instance, certain settings may be selected and saved directly from dialogue window 400 instead of being accessed through one of the settings access buttons in settings access pane 420. Furthermore, the default values may be indicated by other methods, including using differences in color to highlight the default values, or using other graphical indicators.

C. Examples of Discovered Settings

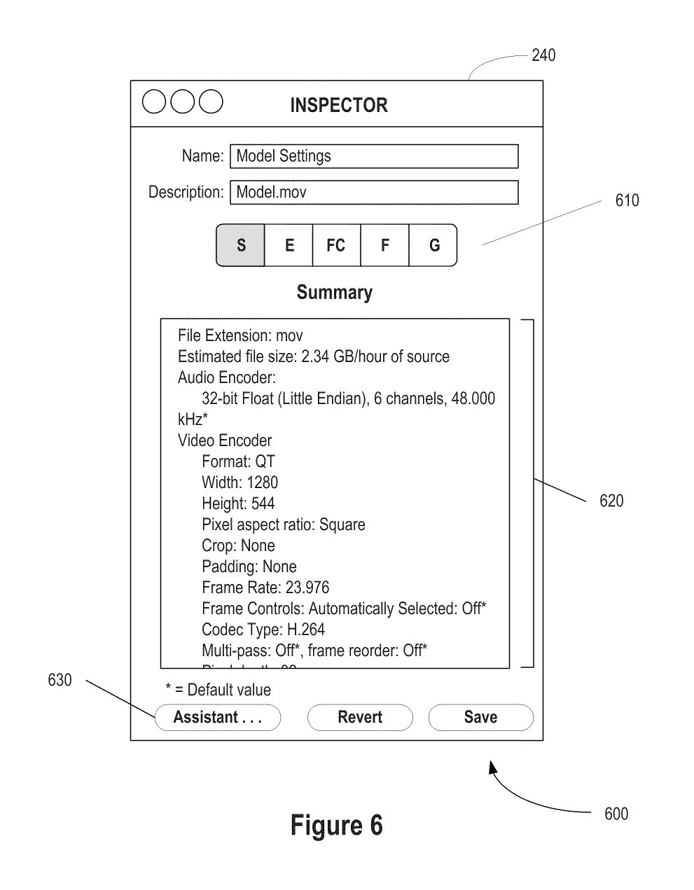

The following discussion will describe in detail a set of discovered settings parameters with reference to FIGS. 6-13 for some embodiments of the invention. FIGS. 6-13 illustrate a series of interface panes for examining and modifying discovered settings. Specifically, in the examples shown in FIGS. 6-13, the interface panes are provided through the inspector window 240 as first introduced with reference to FIG. 2.

FIG. 6 illustrates a summary pane 600 that provides a summary of all the settings produced by the settings discovery tool based on the model media file. Summary pane also shows navigation bar 610, settings summary 620, and assistant launch button 630. Summary pane 600 is one view of inspector window 240 for viewing the discovered settings. Navigation bar 610 is provided for accessing other views of inspector window 240. As shown, the “S” button of navigation bar 610 is selected to display settings summary 620. Default values that were selected by the settings discovery tool are indicated with an asterisk (*). From summary pane 600, settings discovery assistant, as described above with reference to FIGS. 4-5, may be launched by receiving a launch command through input from assistant launch button 630.

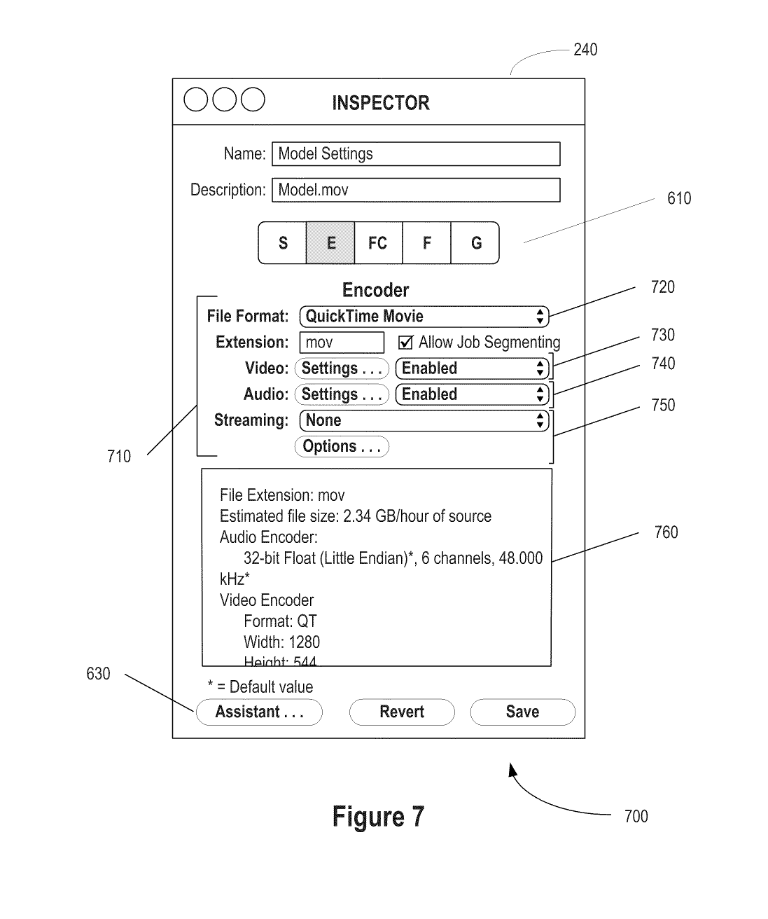

FIG. 7 illustrates an encoder settings pane 700 that provides an interface for viewing and modifying settings parameters specifically related to the encoding portion of the media generating procedure. The encoder settings pane 700 may show different settings parameters depending on the file format that is discovered for the model media settings. Like FIG. 6, FIG. 7 shows navigation bar 610 with the “E” button selected, and assistant launch button 630. FIG. 7 also illustrates various parameters 710 related to the selected file format. In this example, file format selector 720 indicates that settings conform to the QuickTime Movie format. The QuickTime Movie format is associated with video settings, audio settings, and streaming settings, which are enabled and accessible by video settings UI items 730, audio settings UI items 740, and streaming settings UI items 750, respectively. A listing of the values currently selected for particular encoder settings are displayed in encoder summary 760. A user may manually modify any of the discovered encoder settings through the encoder settings pane 700.

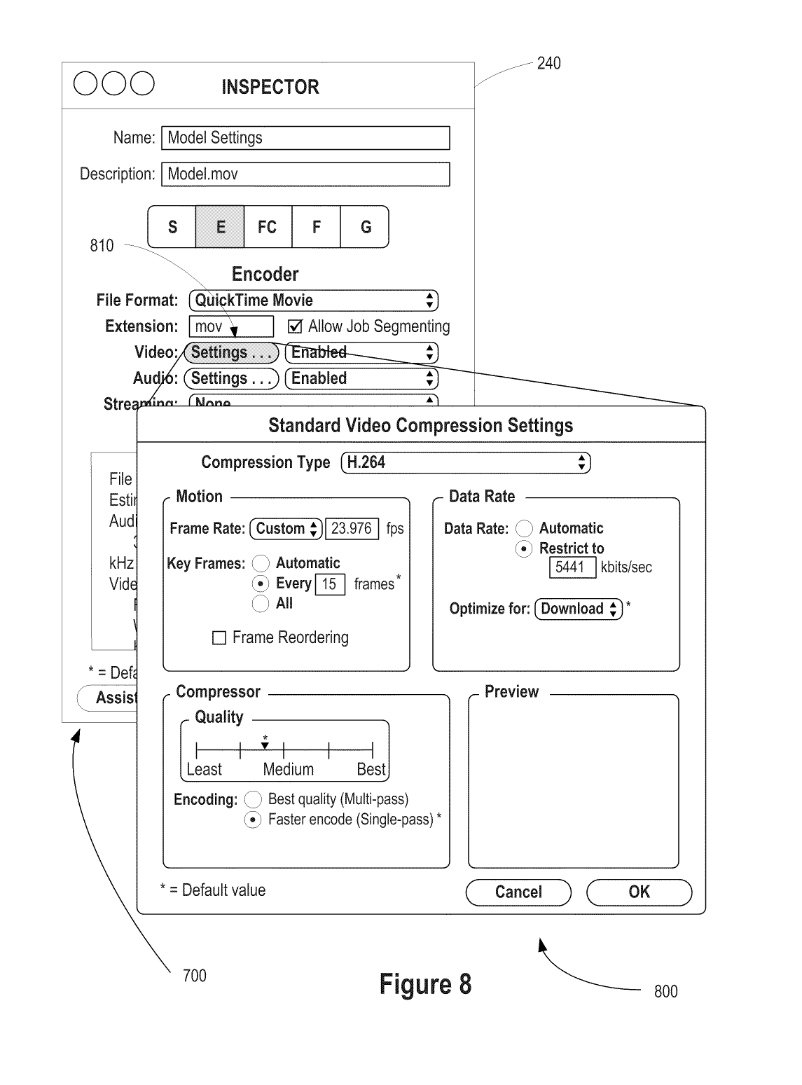

A video settings interface is displayed by selecting the Video settings button 810 as shown in FIG. 8. FIG. 8 illustrates a video settings interface 800 for viewing and modifying video settings. The settings parameters shown in the video settings interface 800 conform to the discovered settings' video file format. In this example, the QuickTime Movie file format and the H.264 compression type was discovered by the settings discovery tool for the model media file. Settings parameters for the H.264 compression type include frame rate, key frames, frame reordering, maximum data rate, data rate optimization, quality, and multi-pass or single-pass encoding. For this example, settings that received default values include key frames, data rate optimization, quality, and multi-pass or single-pass encoding.

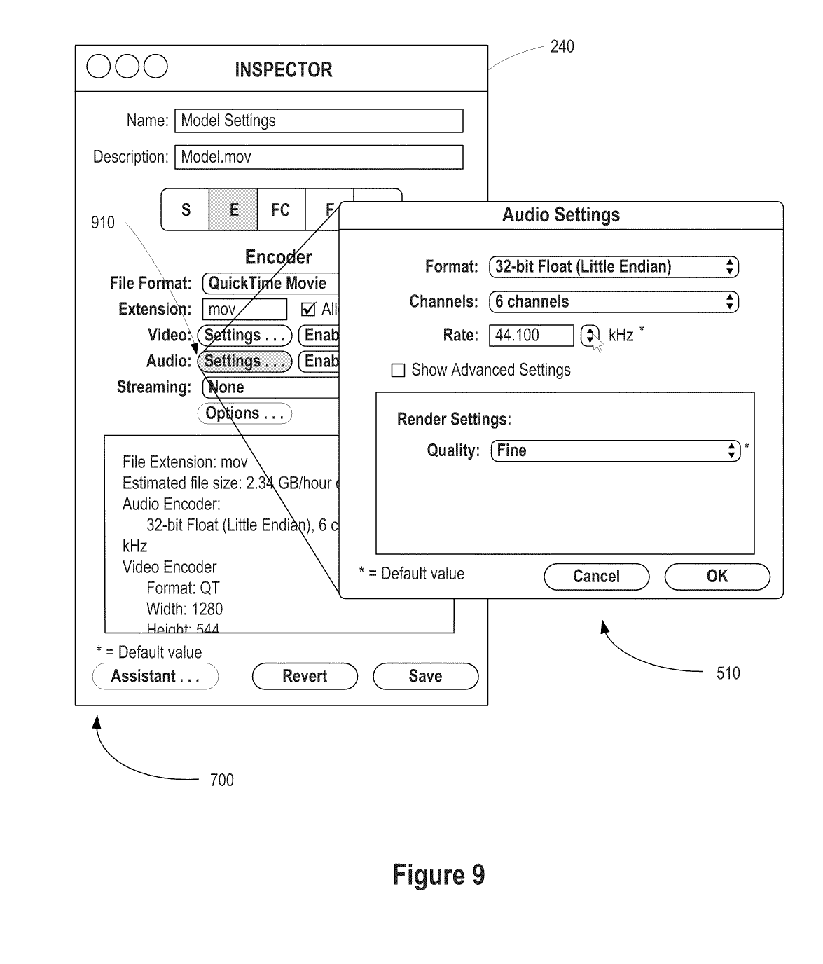

An audio settings interface is displayed by selecting the Audio settings button 910 as shown in FIG. 9. In the example illustrated in FIG. 9, the interface that is shown is identical to the one that is accessed through the settings discovery assistant. In FIG. 9, the audio settings interface 510 shows the stage after a user has manually modified the data rate setting from 48.000 kHz in FIG. 5, to 44.100 kHz in FIG. 9. The settings parameters shown in the audio settings interface 510 conform to the discovered settings' audio file format. In this example, the 32-bit float format is discovered by the settings discovery tool for the model media file. Settings parameters for the 32-bit float format include format, channels, data rate, and render settings. For this example, settings that received default values include the data rate and the render settings.

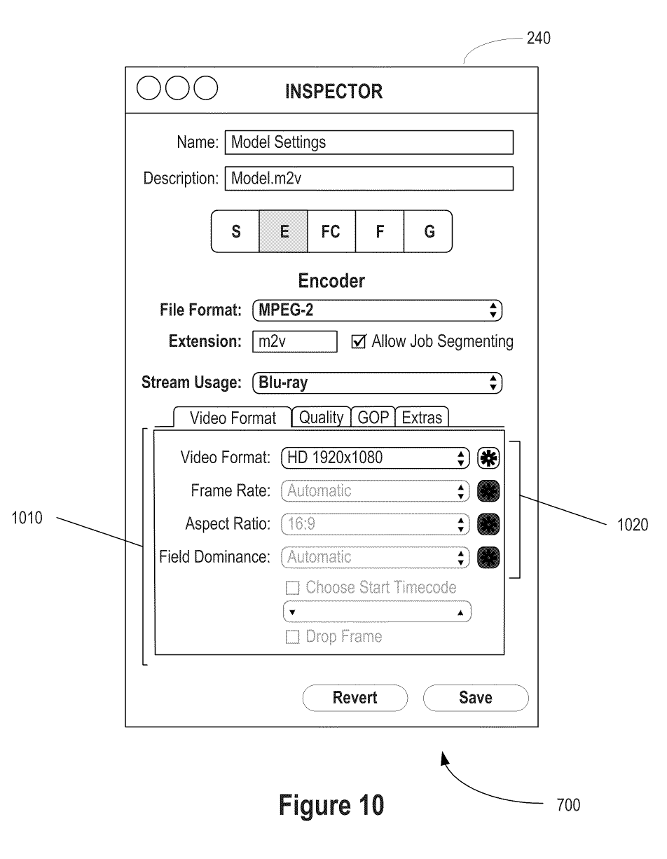

As previously mentioned, the encoder settings pane 700 may show different settings parameters depending on the file format that is discovered for the model media settings. FIG. 10 shows encoder settings pane 700 with settings parameters that were discovered for a model media file with an MPEG-2 file format. The MPEG-2 file format does not encode any audio data. Accordingly, the settings discovery tool does not discover any audio settings from the MPEG-2 media file, and encoder settings pane 700 does not list any audio-related parameters. Instead, encoder settings pane 700 shows video settings 1010, shown in FIG. 10 as directly accessible from Inspector window 240 without opening any other interface window. FIG. 10 also shows a set of settings that are not modifiable because the automatic mode was selected, as indicated by the shading of the automatic toggle buttons 1020.

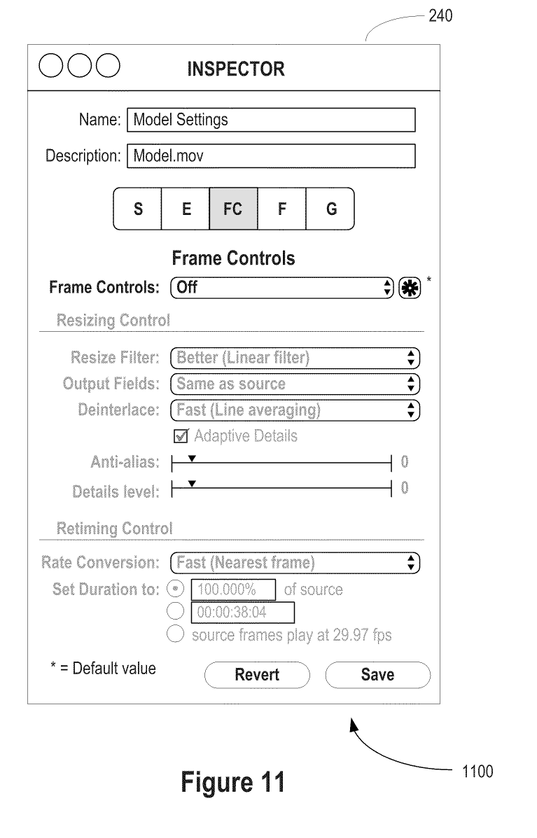

FIG. 11 illustrates a frame controls pane 1100 that provides an interface for viewing and modifying frame controls settings. Frame controls are used to convert video files between international television standards such as PAL to NTSC, or NTSC to PAL, to downconvert high definition (HD) video sources to standard definition (SD), or upconvert SD to HD, to convert a progressive stream to an interlaced one, or interlaced to progressive, and to perform high-quality frame rate adjustments, including high-quality slow-motion effects. Frame controls can also be used to automatically remove 3:2 pull-down from a video sequence. As previously discussed with respect to the settings discovery assistant with reference to FIG. 4, the frame controls that are used to produce a model media file, if any, are generally not discoverable. Accordingly, the frame controls setting default value is set to Off. In some embodiments of the invention, the settings discovery assistant displays frame controls pane 1100, or an interface with similarly arranged elements, when Frame Controls button 434 is selected from the settings discovery assistant.

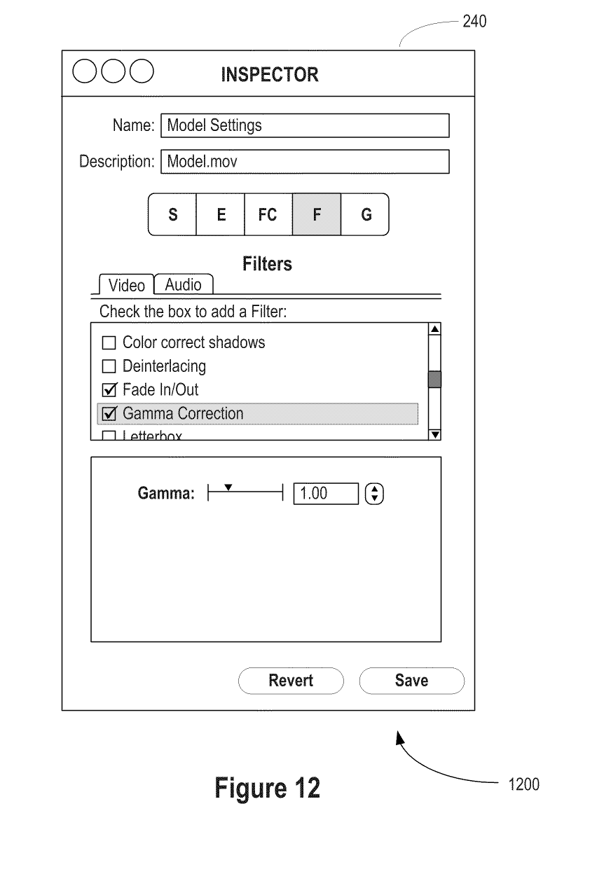

FIG. 12 illustrates a filters pane 1200 that provides an interface for selecting, viewing and modifying audio and video filters. As previously described with reference to FIG. 4, filters refer to a wide range of operations that edit video or audio content by applying treatments to each frame of a video sequence, or to an audio sequence. Filters are available for video editing operations such color correction, gamma correction, deinterlacing, brightness and contrast, and text overlay, and audio editing operations such as dynamic range adjustments and frequency shaping. Whether such filter settings were previously used in encoding the model media file is not discoverable from the model media file because filters generally modify a model media file without notating the difference between the old version and the new version in the media file. Accordingly, the settings discovery tool, by default, assigns an Off value to all filters when producing a set of model media settings. The example as shown in FIG. 12 illustrates that at least two filters have been turned on in the settings. The filters pane 1200 includes an interface pane for modifying the values for filter parameters. As shown, the Gamma Correction parameter and value are displayed in filters pane 1200. In some embodiments of the invention, the settings discovery assistant described with reference to FIG. 4 displays filters pane 1200, or an interface with similarly arranged elements, when Filters button 433 is pressed from the settings discovery assistant.

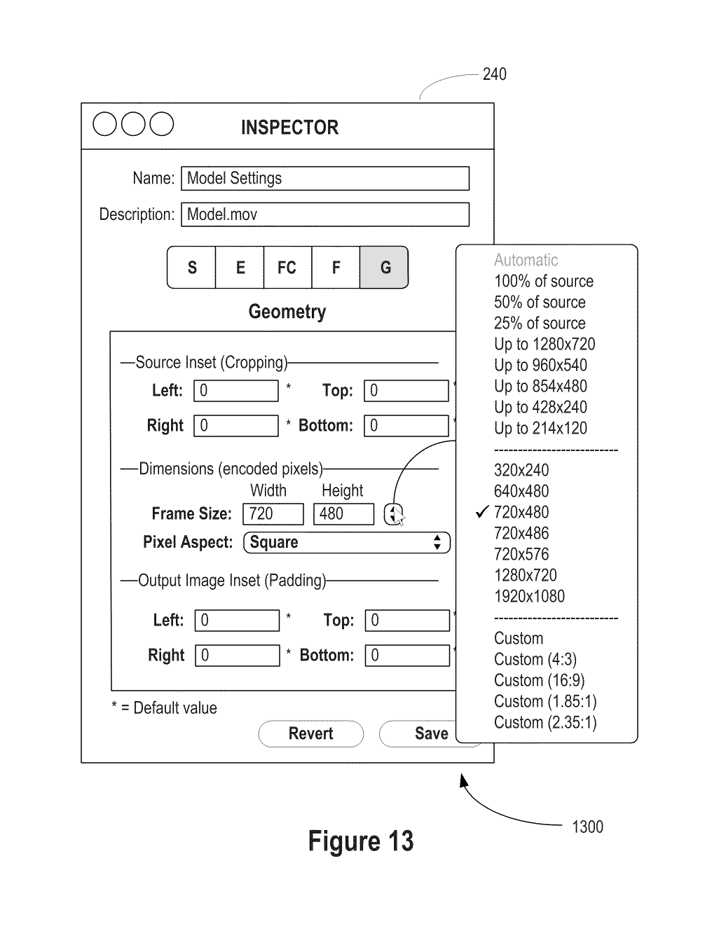

FIG. 13 illustrates a geometry pane 1300 that provides an interface for viewing and modifying geometry parameters. Geometry settings relate to the dimensions of the video frames of a media file. FIG. 13 shows geometry pane 1300 with parameters for image cropping, for setting image dimensions, and for image padding. Image cropping and image padding are typically properties that are not discoverable from the model media file (e.g. whether the model media file is generated by cropping out letterbox bars, or was originally in a widescreen aspect ratio without any use of letter box bars, is not discoverable). Accordingly, the default values for the cropping or padding parameters are set to zero by the settings discovery tool. In contrast, the dimensions of the frame size are often notated in the media file, and are able to be read directly from metadata in the media file.

II. Processes for Automatic Media Settings Discovery

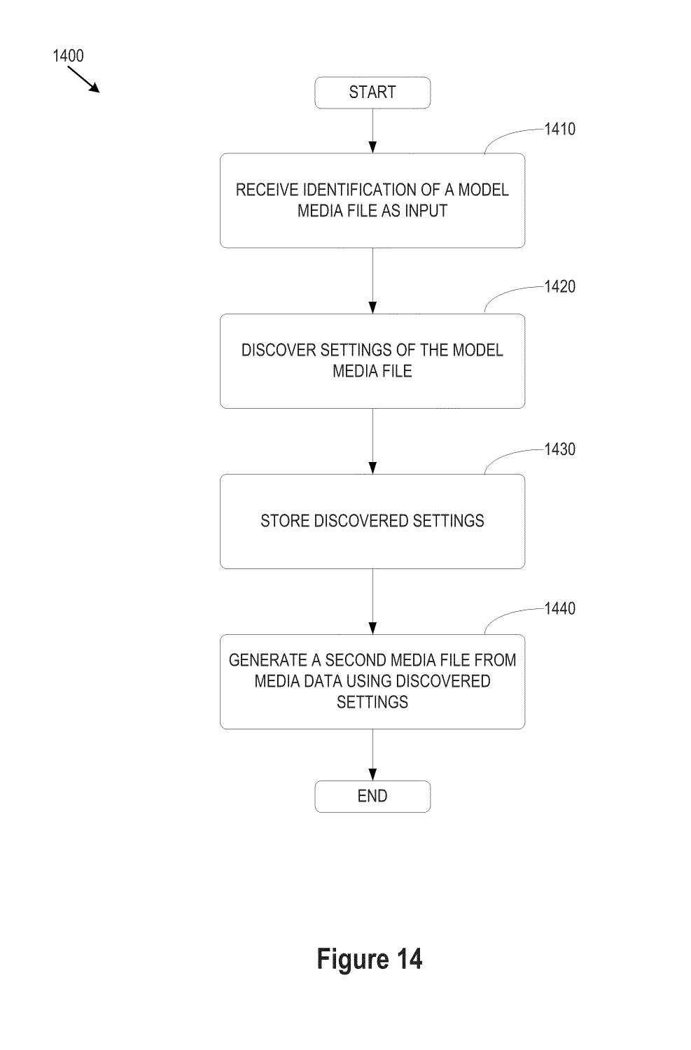

FIGS. 14-19 illustrate examples of conceptual machine-executed processes that provide (1) a settings discovery tool for discovering media settings from a model media file, and (2) a media generation tool for generating another media file using the media settings that were discovered from the model media file. The specific operations of the process may not be performed in the exact order described. The specific operations may not be performed as one continuous series of operations. Different specific operations may be performed in different embodiments. Furthermore, the process could be implemented using several sub-processes, or as part of a larger macro-process.

For some embodiments of the invention, FIG. 14 illustrates an example of a conceptual machine-executed process executed by the media processing application for discovering settings from a media file, and for generating another media file using the discovered settings. The process 1400 begins by receiving (at 1410) a model media file as input. For some embodiments, the input is a reference to the model media file (e.g. a uniform resource locator, or “URL”). For some embodiments, the input is a copy of the model media file. The model media file contains digital audio or video data that represents sounds or images, respectively, that can be presented through a digital media player. For some embodiments, the input is received at a graphical user interface (GUI) of a settings discovery tool of a media processing application. For some embodiments, the input is received as a parameter value provided with a command at a command line interface to launch a settings discovery tool.

The process discovers (at 1420) settings of the model media file. The settings correspond to the format and the properties of the model media file. The process analyzes the file's data to determine the file's format and properties. The file's format and properties are extrapolated into specific settings that can be used by the media generation tool to generate another file.

Once the settings of model media file are discovered, the process stores (at 1430) the discovered settings. For some embodiments, the settings are stored as a set of data records within a data structure maintained by the media processing application. For some embodiments, the set of data records are stored as a data file that is accessible by the media processing application.

The process generates (at 1440) a new media file from media data using the discovered settings. Media data describes any data that represents sounds and/or images, including data from a media editing application, such as Apple's Final Cut Pro® or iMovie®, data from an electronic image sensor on a video camera, such as a CCD sensor, or data from a media file encoded with a particular codec, such as a QuickTime movie media file. Using the settings to generate the new media file causes the new media file to have similar, if not identical, audio and video properties as the model media file. For some embodiments, the process allows a user to modify the discovered settings before they are used for generating another media file. For some embodiments, the media processing application may employ a distributed processing system to divide the data sequence in the source version into different segments, and to have multiple computers generate each segment simultaneously. Such an application includes Apple Qmaster®, sold by Apple Inc.

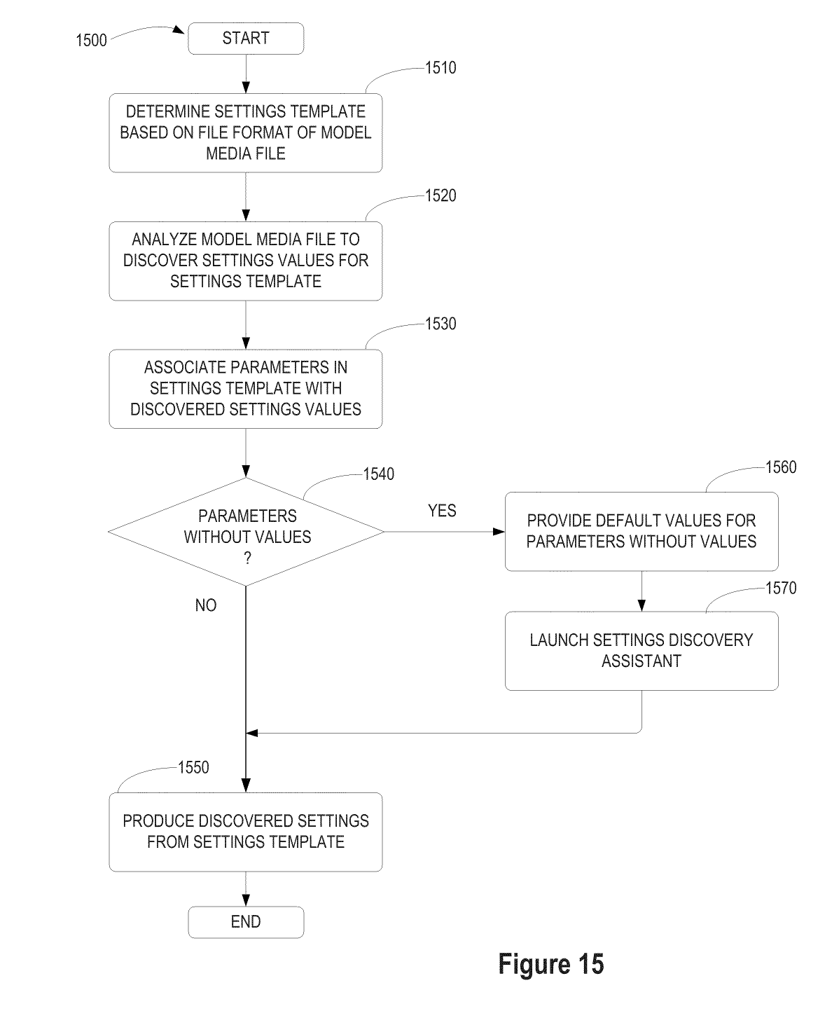

The operation identified at 1420 is further described in detail by reference to FIG. 15. For some embodiments of the invention, FIG. 15 illustrates an example of a conceptual machine-executed process 1500 for discovering settings from a model media file as executed by the settings discovery tool. The settings discovery tool is activated when a reference to model media file is received by the tool as input. The process 1500 determines (at 1510) a settings template based on the file format of the model media file. The settings template identifies the settings parameters that are applicable to the file format. Not all formats support all settings. For example, while a QuickTime Movie media file has both audio and video data, and therefore a settings for QuickTime Movie file format requires both audio and video settings to generate a QuickTime Movie media file. However, an MPEG-2 media file has only video data, and therefore settings for an MPEG-2 file format requires only video settings. In some embodiments of the invention, the settings template is also a data structure into which values may be associated with each of the parameters listed in the settings template.

The process 1500 analyzes (at 1520) the model media file to discover settings values for each of the parameters listed in the settings template. For each discovered value, the process 1500 associates (at 1530) the value with the appropriate parameter in the settings template.

The process 1500 examines the settings template to determine whether there are any parameters without values. If the settings template is complete, the process 1500 produces (at 1550) discovered settings from the settings template. If the settings template is not complete, the process 1500 determines (at 1560) default values for each of the absent parameters. In this example of some embodiments of the invention, the process 1500 launches (at 1570) the settings discovery assistant to assist the user in modifying the default values provided by the process. In some other embodiments, after the process 1500 provides the default values, the process 1500 produces discovered settings from the settings template with the default values without launching any settings discovery assistant.

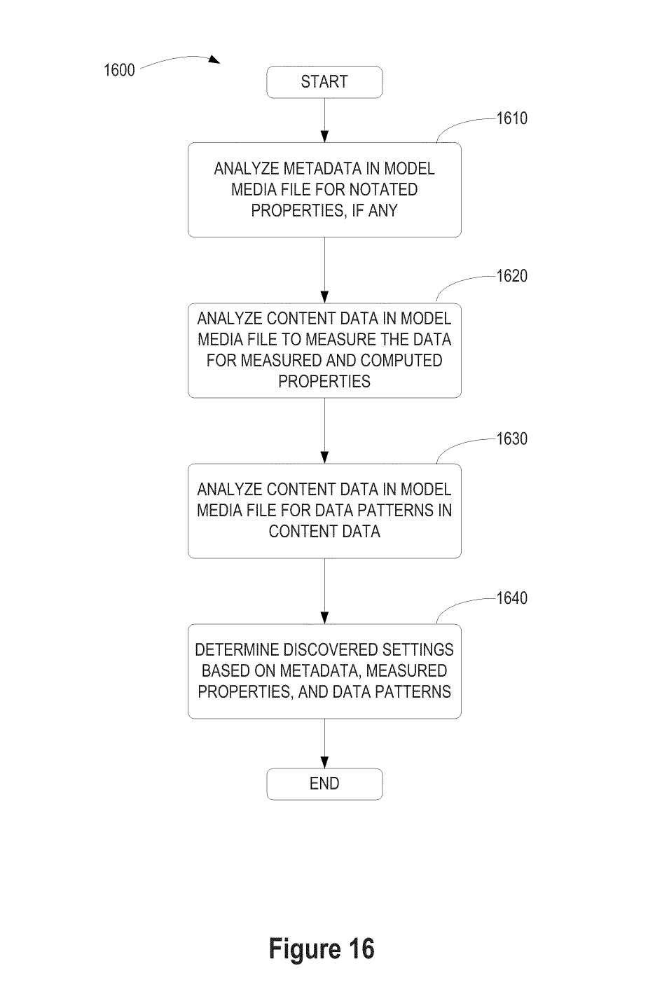

The operation identified at 1520 is further described in detail by reference to FIG. 16. For some embodiments of the invention, FIG. 16 illustrates an example of a conceptual machine-executed process 1600 for analyzing the model media file to discover settings values for each of the parameters listed in the settings template. The process 1610 analyzes (at 1610) metadata in the model media file for notated properties to read as values for settings. In some embodiments of the invention, the settings discovery tool makes a function call to an application programming interface (API) of the file format of the model media file that supplies instructions to execute to query the data from the model media file. Notated properties include properties such as frame size in pixels, the video and audio codec of the model media file, and the number of channels in the audio data.

The process 1600 analyzes (at 1620) the content data in the model media file to measure the data for measured and counted properties, such as data size, frame count, and duration. The measurements may be used to compute the data rate setting and other computed settings. The process 1600 also analyzes (at 1630) the content data in the model media file for data patterns in the content data. Data patterns include determining a repetition pattern in the image frames of the video data to determine whether a 3:2 pulldown operation has been applied.

Finally, the process 1600 determines a set of values that correspond to particular parameters using the notated properties, measured properties, computed properties, and data patterns identified in the operations described above.

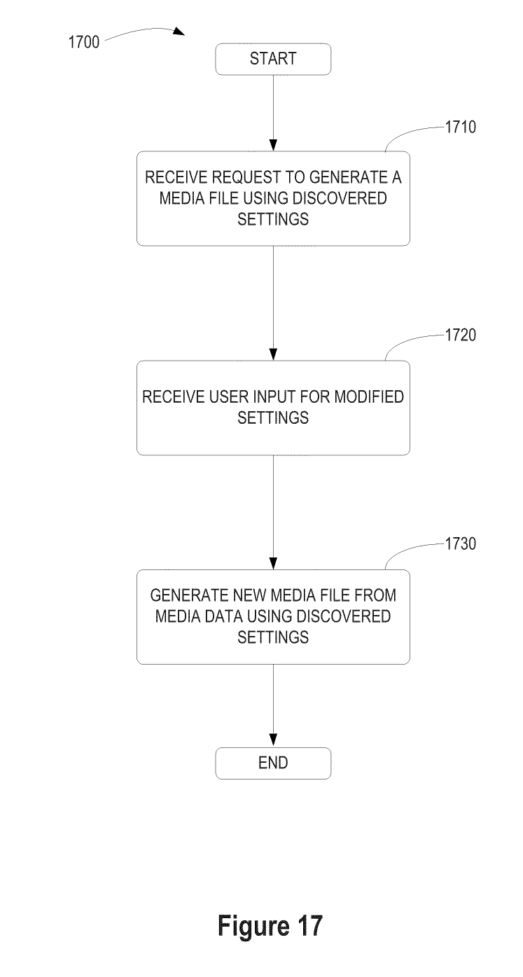

After the process 1500 produces discovered settings, the settings may be used to generate a new media file by a conceptual machine-executed process 1700 as described by reference to FIG. 17. The process 1700 receives (at 1710) a request to generate a media file using discovered settings. For some embodiments, the request identifies the set of discovered settings, and identifies media data from which to generate the new media file. In some embodiments, the set of discovered settings is identified when a user drags-and-drops a UI element representing the settings into the GUI. This drag-and-drop operation is illustrated in FIG. 3.

In some embodiments of the invention, the process 1700 receives (at 1720) either solicited or unsolicited user input for modifying the settings. In some embodiments, the process 1700 launches a settings discovery assistant to guide the user through the possible variables and values that can be selected for each of the settings parameters. In some embodiments, the process receives modifications from the user that are not solicited by any settings discovery assistants. Finally, the process 1700 generates (at 1730) the new media file using the discovered settings.

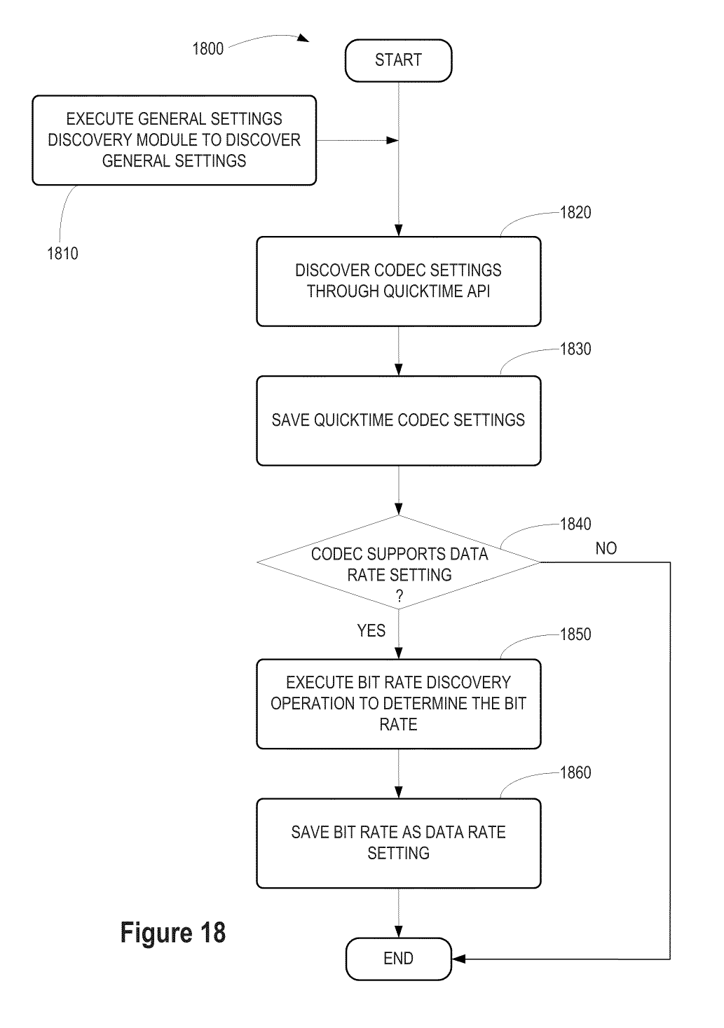

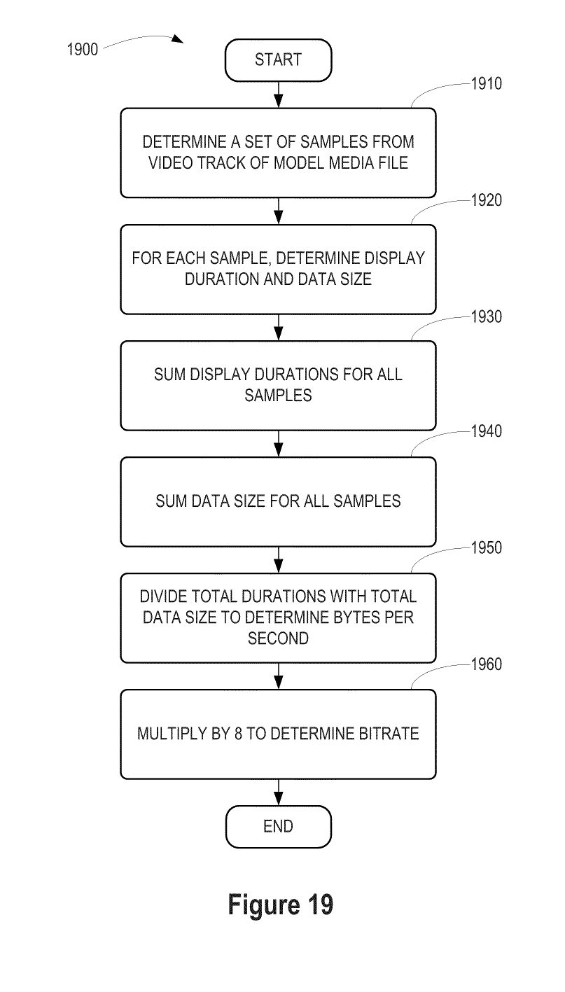

For some embodiments of the invention, FIGS. 18-19 illustrate examples of conceptual machine-executed processes for discovering specific types of settings. In these examples, general settings that are common to all media file formats are discovered first by a general discovery module. Such general settings include video and audio codecs, frame dimensions, duration, natural bounding box, natural field dominance, color specification, and pixel aspect ratio. The codec-specific operations that are called depend on the codec type of the model media file discovered by the general settings module.

The process 1800 as illustrated in FIG. 18 performs settings discovery for a model media file that has a QuickTime Movie file format. The process 1800 begins by executing (at 1810) a general settings discovery module to discover general settings for the QuickTime Movie model media file. The process 1800 discovers (at 1820) specific codec settings through the QuickTime API. Such codec settings include the temporal quality and a spatial quality used to encode the model media file. The process 1800 saves (at 1830) the discovered QuickTime codec values with the corresponding parameters in the settings template.

Process 1800 determines (at 1840) whether the QuickTime codec supports a data rate setting. A data rate setting is only supported by codecs that allow for the data rate to be varied. If a data rate setting is not supported, the process 1800 ends. If the data rate setting is supported, the process 1800 executes (at 1850) a bit rate discovery operation to discover the bit rate. When the operation returns the bit rate, the process 1800 saves (at 1860) the bit rate as a data rate setting.

FIG. 19 illustrates the bit rate discovery operation as identified at 1850 by reference to FIG. 18. The process 1900 determines (at 1910) a set of samples from a video track of a model media file. For some embodiments of the invention, the process 1900 determines up to 500 samples for analysis. The process 1900 determines (at 1920) for each sample a display duration and a data size. The process 1900 sums (at 1930) the display duration for each of the samples. In some embodiments, the display duration is measured in seconds. The process 1900 sums (at 1940) the data sizes for all samples. The data sizes in some embodiments are measured bytes. The process 1900 divides (at 1950) the total summed durations with the total summed sizes to determine a data rate in bytes per second. The process 1900 divides (at 1960) the data rate in bytes per second by 8 to determine a bit rate for the data sequence.

III. Software Architecture

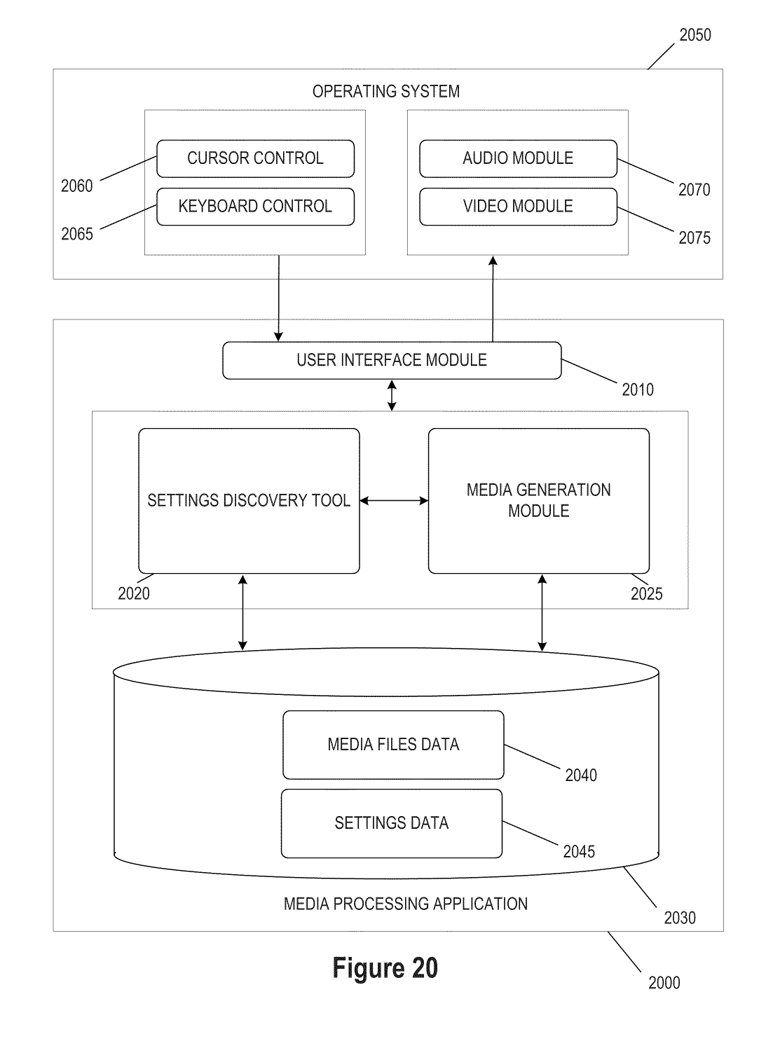

In some embodiments, the processes described above are implemented as software running on a particular machine, such as a computer or a handheld device, or stored in a computer readable medium. FIG. 20 conceptually illustrates the software architecture of a media processing application 2000 of some embodiments for providing (1) one or more tools to allow a user to identify model media content, (2) a settings discovery module that can automatically discover settings from the model media content, and (3) a media generation tool for generating a digital media file using the media settings that were discovered from the model media file as described in the preceding sections. In some embodiments, the application is a stand-alone application or is integrated into another application (for instance, application 2000 might be a portion of a video-editing application), while in other embodiments the application might be implemented within an operating system. Furthermore, in some embodiments, the application is provided as part of a server-based (e.g., web-based) solution. In some such embodiments, the application is provided via a thin client. That is, the application runs on a server while a user interacts with the application via a separate client machine remote from the server (e.g., via a browser on the client machine). In other such embodiments, the application is provided via a thick client. That is, the application is distributed from the server to the client machine and runs on the client machine.

As shown in FIG. 20, the media processing application 2000 includes a user interface module 2010 for sending data to and receiving data from a user, a settings discovery tool 2020 for processing settings discovery operations, including managing user input received from user interface module 2010 through a settings discovery assistant, a media generation module 2025 for generating a new media file from media data using discovered settings, and storage 2030 for storing data used by the application 2000. Storage 2030 stores media files data 2040, settings data 2045, as well as other data used by media processing application 2000.

Media files data 2040 include media data, the templates associated with the media file format, and any API functions that are called by the settings discovery tool. Media data describes any data that represents sounds and/or images, including data from a media editing application, such as Apple's Final Cut Pro® or iMovie®, data from an electronic image sensor on a video camera, such as a CCD sensor, or data from a media file encoded with a particular codec, such as a QuickTime movie media file. Settings data 2045 include the completed sets of saved settings after the settings discovery tool completes settings discovery.

FIG. 20 also illustrates several components of operating system 2050 that provide input to, and receives output from, media processing application 2000 via user interface module 2010. Such components include cursor control 2060 that allows the application 2000 to receive data from a cursor control device, keyboard control 2065 that allows the application 2000 to receive data from a keyboard, audio module 2070 for processing audio that that will be supplied to an audio output device (e.g. speakers), and video module 2075 for processing video data that will be supplied to a display device (e.g., a monitor).

A user interacts with items in the user interface of the media processing application 2000 via input devices (not shown) such as a pointing device (e.g., a mouse, touchpad, trackpad, etc.) and keyboard. The input from these devices is processed by the cursor control 2060 and keyboard control 2065, and passed to the user interface interaction module 2010.

The present application describes a graphical user interface that provides users with numerous ways to perform different sets of operations and functionalities. In some embodiments, these operations and functionalities are performed based on different commands that are received from users through different input devices (e.g., keyboard, trackpad, touchpad, mouse, etc). For example, the present application describes the use of a cursor in the graphical user interface to control (e.g., select, move) objects in the graphical user interface. However, in some embodiments, objects in the graphical user interface can also be controlled or manipulated through other controls, such as touch control. In some embodiments, touch control is implemented through an input device that can detect the presence and location of touch on a display of the device. An example of such a device is a touch screen device. In some embodiments, with touch control, a user can directly manipulate objects by interacting with the graphical user interface that is displayed on the display of the touch screen device. For instance, a user can select a particular object in the graphical user interface by simply touching that particular object on the display of the touch screen device. As such, when touch control is utilized, a cursor may not even be provided for enabling selection of an object of a graphical user interface in some embodiments. However, when a cursor is provided in a graphical user interface, touch control can be used to control the cursor in some embodiments.

The user interface module 2010 translates the data from the controls 2060 and 2065 into the user's desired effect on the media processing application 2000. Settings discovery tool 2020 and media generation module 2025 use such input to carry out the operations as described with reference to FIGS. 14-19 above. For example, when a user moves a cursor to select media data as input, or selects a set of discovered settings to generate a new media file using the discovered settings, user interface module 2010 receives such input from the user, and translates the input into commands that can be processed by settings discovery tool 2020 or media generation module 2025.

In some embodiments, the user interface module 2010 implements a settings discovery window for receiving an identification of a media file. The reception of the identification of the media file is monitored by a monitoring module that is implemented by the settings discovery tool 2020. In some embodiments, the monitoring module employs a polling process to determine at regular intervals whether new content has been received at the setting discovery user interface window. In other embodiments, the user-interface instructions that define the setting discovery window include a set of instructions that sends a message to the monitoring module to notify this module that an identification of model media content has been received.

The following describes the interaction between the modules according to one example of some embodiments of the invention. Settings discovery tool 2020 receives notification from the monitoring module that a model media file has been identified, and automatically begins settings discovery processes. In particular, settings discovery tool 2020 begins accessing media files data 2040 from storage 2030 to retrieve data from the referenced media file, and to access file format APIs for discovering certain file format-specific settings. Settings discovery tool 2020 saves the discovered settings in settings data 2045.

Media generation module 2025 uses the saved discovered settings, as well any encoding instructions stored in storage 2030 that are necessary, to generate a new media file. Media generation module 2025, after generating the new media file, provides access to the new media file to the user through the user interface module 2010.

While many of the features have been described as being performed by one module (e.g., the user interface module 2010 or settings discovery tool 2020), one of ordinary skill would recognize that a particular operation might be split up into multiple modules, and the performance of one feature might even require multiple modules in some embodiments.

One of ordinary skill in the art will recognize that the conceptual descriptions provided above in reference to FIG. 20 may be implemented using different embodiments without departing from the spirit of the invention. For instance, storage 2030 described above with reference to FIG. 20 may be implemented as various storage elements. Furthermore, the operations performed by media generation module 2025 may be performed by other media file generation module that does not convert from one media file format to another media file format. Instead, such a media generation module may be implemented inside a video camera recorder that receives image data from an image sensor through a video camera lens, and generates a media file from the image data using the settings discovered by the settings discovery tool.

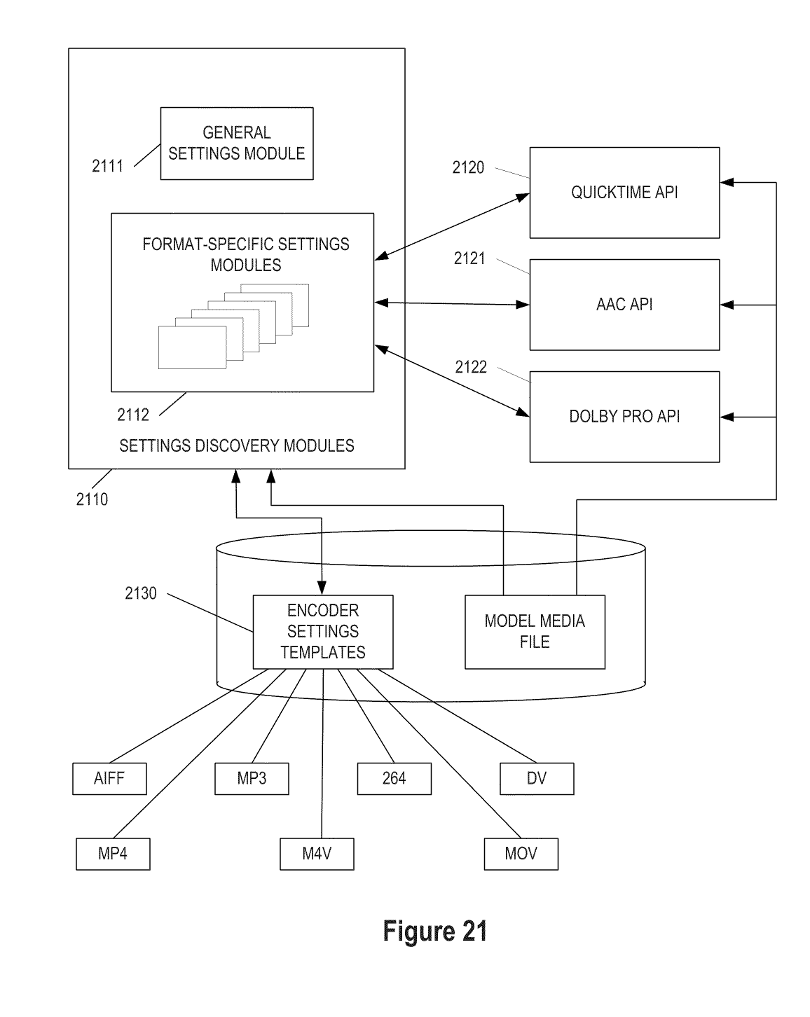

FIG. 21 conceptually illustrates the software architecture of settings discovery tool 2020 described above with reference to FIG. 20. As shown in FIG. 21, settings discovery tool includes a set of settings discovery modules 2110 that perform the operations described above by reference to FIGS. 15, 16, 18, and 19. The settings discovery modules 2110 include a general settings discovery module 2111 for discovering general settings, and a set of format-specific settings modules 2112 that are specific to the particular file format of the model media file.

FIG. 21 also includes a set of file format APIs, QuickTime API 2120, AAC API 2121, and Dolby Pro API 2122. Each of the file format APIs are called by a corresponding format-specific discovery module to discover certain settings from a model media file. For instance, a QuickTime settings discovery module calls the QuickTime API 2121 for discovering QuickTime-specific settings.

FIG. 21 includes a set of encoder settings templates that specify settings that are applicable for each of the file formats. The general settings module 2111 and the format-specific settings module 2112 use the templates to determine which settings need to be discovered from the model media file. For some embodiments, the templates also include data structures into which discovered values may be stored and organized. A set of settings from a completed template may be saved for later use by a media generation module.

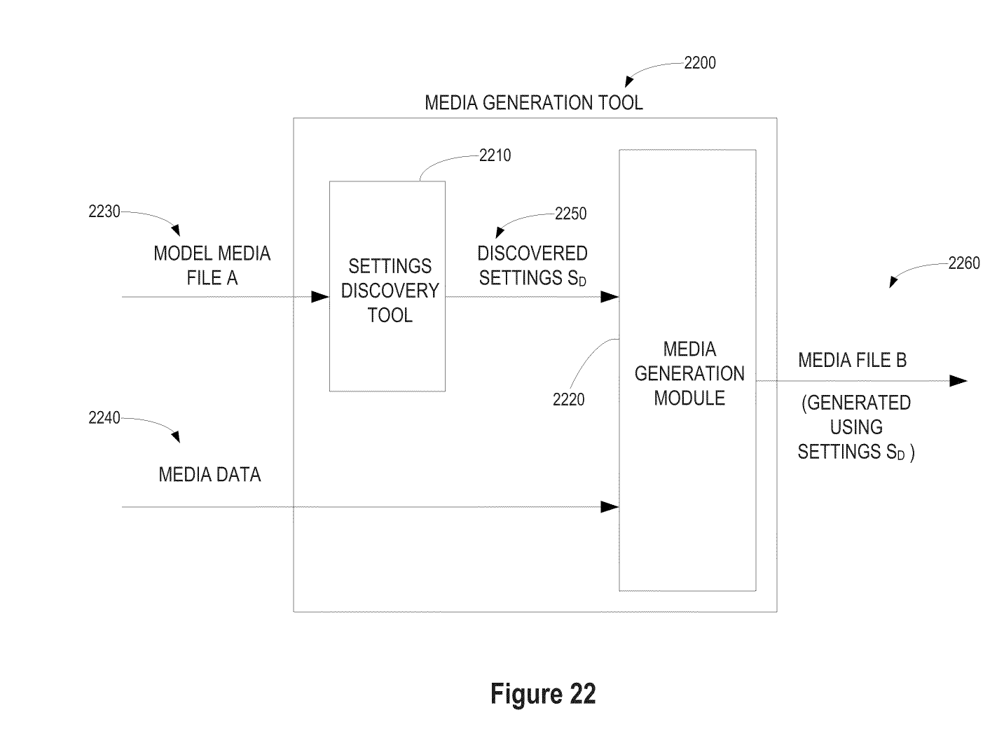

For some embodiments of the invention, FIG. 22 illustrates the flow of data in and out of such a media generation tool for generating a media file using the settings that were discovered from the model media file. Specifically, this figure shows the media generation tool receiving, as input, a model media file and a set of media data, and outputting a media file that was generated using discovered settings. The example illustrated can be implemented using a variety of interfaces, including a command-line interface or a graphical user interface (GUI).

FIG. 22 shows media generation tool 2200, which operates to encode media data into a media file using a set of settings parameters and values, referred to collectively as settings. Media generation tool 2200 provides: (1) a settings discovery tool 2210 and (2) a media generation module 2220. FIG. 22 also shows model media file A 2230, a set of media data 2240, discovered settings S_{D} 2250, and a media file B 2260 that is generated using discovered settings S_{D} 2250.

Settings discovery tool 2210 receives as input model media file A 2230. Settings discovery tool 2210 executes settings discovery operations to determine settings that correspond to the format and the properties of a model media file. Settings discovery operations include analyzing model media file A 2230 to determine the file's format and properties, and extrapolating the file's format and properties into specific settings that can be used by the media generation tool to generate a new media file.

All the parameters and values determined from metadata, from computations, and from user input are collected as a set of discovered settings S_{D} 2250. For some embodiments, discovered settings S_{D} 2250 are stored as a set of data records within a data structure maintained by the media processing application. For some embodiments, the set of data records are stored as a data file that is accessible by the media processing application.

For some embodiments, the format of the model media file A 2230 is the determining factor in establishing which set of parameters to include in the settings. Certain formats do not support certain settings, and certain formats require certain settings. Based on the format, settings discovery tool 2210 identifies a template of parameters for which values need to be discovered. The settings discovery tool 2210 uses metadata, computations, and user input to discover values for each parameter.

Media generation module 2220 takes discovered settings SD 2250 and media data 2240 as input, and applies the discovered settings S_{D} 2250 to generate a media file from media data 2240. If the format of the media data 2240 and the format specified in discovered settings S_{D} 2250 are the same, media file B 2260 is generated with only adjustments to the properties of the media data 2240 without any format change. Alternatively, if the format of media data 2240 and the format specified in discovered settings S_{D} 2250 were different, the media generation module 2220 produces media file B 2260 with a format change, as well as with any adjustments to the properties as specified in discovered settings S_{D} 2250.

The following describes the operation of media generation tool 2200 by reference to FIG. 22 for some embodiments of the invention. Settings discovery tool 2210 receives model media file A 2230 as input. The input may be received through a variety of different user interfaces. For some embodiments, the input is received as a parameter value for a settings discovery command in a command-line interface. Alternatively, the input is received as a media file icon that is dragged and dropped into a settings discovery tool GUI.

Settings discovery tool 2210 performs the settings discovery operations described above to produce a set of discovered settings S_{D} 2250 for media generation tool 2200. As mentioned above, the set of discovered settings S_{D} 2250 are data records that may be stored in a variety of ways, including as a data structure maintained by the media processing application, or as a data file that is accessible by the media processing application.

The media generation module 2220 receives a request to perform a conversion on a media data 2240 to generate a media file using discovered settings S_{D} 2250. For some embodiments, the request is received as a conversion command in a command-line interface, and source version 2240 and discovered settings S_{D} 2250 are parameter values specified with the command. Alternatively, the request may be submitted through a GUI.

The settings discovery tool 2210 passes discovered settings S_{D} 2250 and source version 2240 to media generation module 2220 to generate a media file using discovered settings S_{D} 2250. For some embodiments, media generation module 2220 is a set of processing nodes implemented on different computer systems, and media data 2240 is segmented into multiple segments. The media processing application passes each of the segments, along with a copy of discovered settings S_{D} 2250, to any one of the nodes for processing.

Media generation module 2220 produces media file B 2260 that was generated using discovered settings S_{D} 2250. For some embodiments, media file B 2260 is assembled by a distributed processing application from a sequence of segments that were processed separately on different computer systems. For some embodiments, media file B2260, having been generated using settings S_{D} 2250 that were discovered based on the format and properties of model media file A 2230, has a format and properties that are identical to those of model media file A 2230.

VI. Process for Defining a Media Processing Application

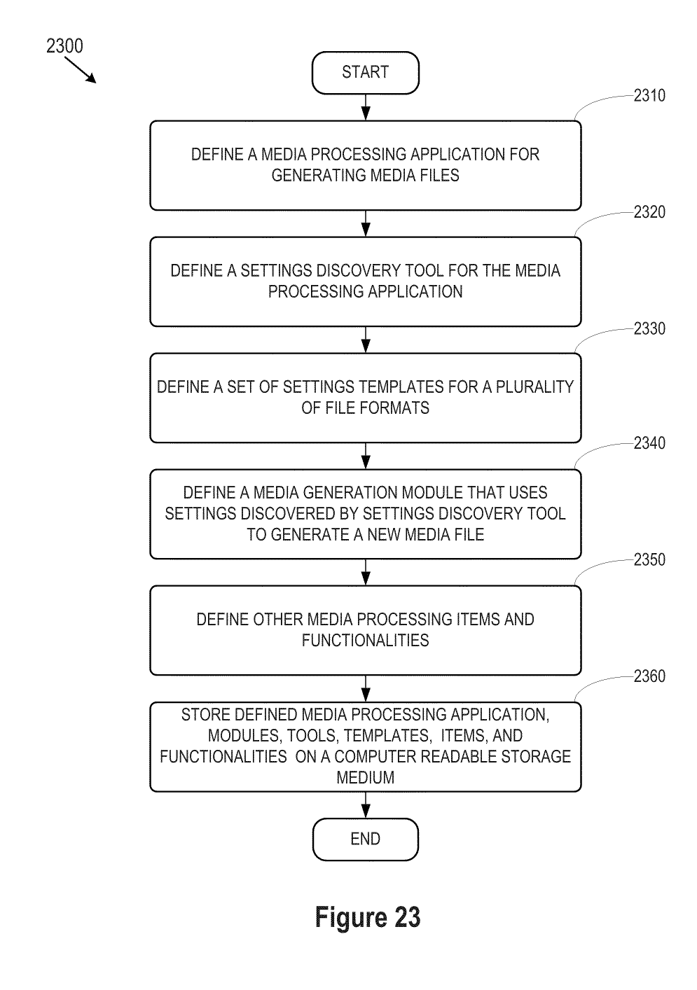

FIG. 23 conceptually illustrates a process 2300 of some embodiments for defining and storing a media processing application of some embodiments, such as application 2000. Specifically, process 2300 illustrates the operations used to define several of the elements shown in media processing application 2000. As shown, process 2300 begins by defining (at 2310) a media processing application for discovering settings from a model media file, and for converting another media file. Media processing application 2000 is one example of such an application.

The process then defines (at 2320) a settings discovery tool for the media processing application. The settings discovery tool may be implemented in a graphical user interface, or in a command-line interface. The settings discovery tool may be implemented as part of a media processing application, or may be separately defined and accessible to the media processing application.

The process then defines (at 2330) a set of settings templates for a plurality of file formats. The settings templates identify the settings that are applicable to a particular file format. The settings templates may be filled with values, and saved as a set of settings that are inputted into media processing application for generating a media file.

The process then defines a media generation module that uses the settings discovered by the settings discovery tool to generate a media file.

The process then defines (at 2350) other media processing items and functionalities. Examples of such media processing items include transcoding operations, audio and video filters, and frame controls operations. Such functionalities may include library functions, format conversion functions, etc. The process defines these additional tools in order to create a media processing application that has many additional features to the features described above.

Process 2300 then stores (at 2360) the defined media processing application (i.e., the defined modules, UI items, etc.) on a computer readable storage medium. The computer readable storage medium may be a disk (e.g., CD, DVD, hard disk, etc.) or a solid-state storage device (e.g., flash memory) in some embodiments. One of ordinary skill in the art will recognize that the various elements defined by process 2300 are not exhaustive of the modules, rules, processes, and UI items that could be defined and stored on a computer readable storage medium for a media processing application incorporating some embodiments of the invention. In addition, the process 2300 is a conceptual process, and the actual implementations may vary. For example, different embodiments may define the various elements in a different order, may define several elements in one operation, may decompose the definition of a single element into multiple operations, etc. In addition, the process 2300 may be implemented as several sub-processes or combined with other operations within a macro-process.

V. Computer System

Many of the above-described processes and modules are implemented as software processes that are specified as a set of instructions recorded on a computer readable storage medium (also referred to as “computer readable medium” or “machine readable medium”). When these instructions are executed by one or more computational element(s), such as processors or other computational elements like application-specific ICs (“ASIC”) and field-programmable gate arrays (“FPGA”), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc. The computer readable media does not include carrier waves and/or electronic signals passing wirelessly or over wired connections.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs when installed to operate on one or more computer systems define one or more specific machine implementations that execute and perform the operations of the software programs.

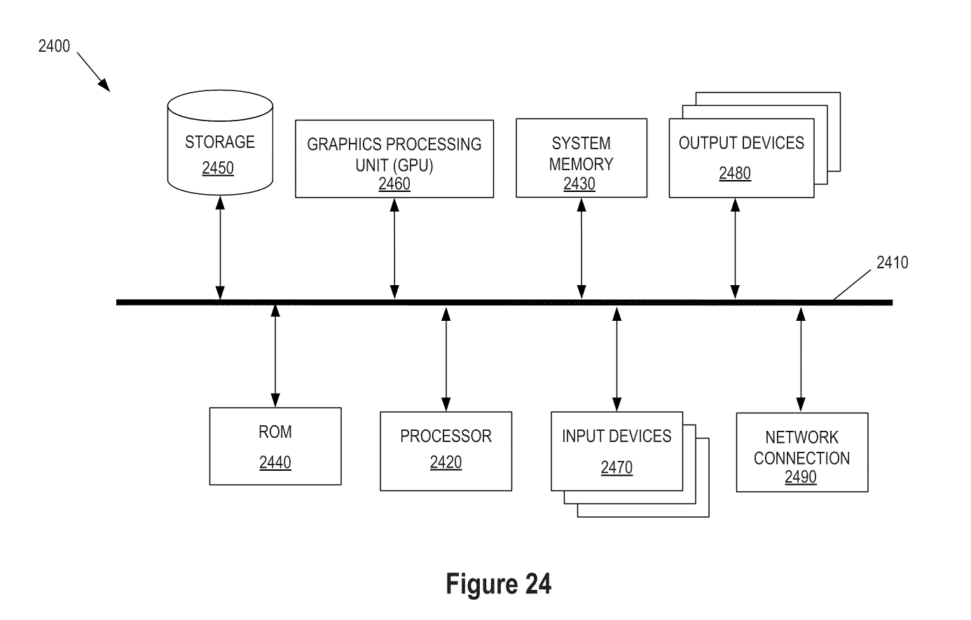

FIG. 24 illustrates a computer system with which some embodiments of the invention are implemented. Such a computer system includes various types of computer readable mediums and interfaces for various other types of computer readable mediums. Computer system 2400 includes a bus 2405, a processor 2410, a graphics processing unit (GPU) 2420, a system memory 2425, a read-only memory 2430, a permanent storage device 2435, input devices 2440, and output devices 2445, and a network connection 2490. The components of the computer system 2400 are electronic devices that automatically perform operations based on digital and/or analog input signals. The various examples of user interfaces shown in FIGS. 1-13 may be at least partially implemented using sets of instructions that are run on the computer system 2400 and displayed using the output devices 2480.

One of ordinary skill in the art will recognize that the computer system 2400 may be embodied in other specific forms without deviating from the spirit of the invention. For instance, the computer system may be implemented using various specific devices either alone or in combination. For example, a local PC may include the input devices 2470 and output devices 2480, while a remote PC may include the other devices 2410-2460, with the local PC connected to the remote PC through a network that the local PC accesses through its network connection 2490 (where the remote PC is also connected to the network through a network connection).

The bus 2405 collectively represents all system, peripheral, and chipset buses that communicatively connect the numerous internal devices of the computer system 2400. For instance, the bus 2405 communicatively connects the processor 2410 with the read-only memory 2430, the GPU 2420, the system memory 2425, and the permanent storage device 2450. In some cases, the bus 2410 may include wireless and/or optical communication pathways in addition to or in place of wired connections. For example, the input devices 2470 and/or output devices 2480 may be coupled to the system 2400 using a wireless local area network (W-LAN) connection, Bluetooth®, or some other wireless connection protocol or system.

From these various memory units, the processor 2410 retrieves instructions to execute and data to process in order to execute the processes of the invention. In some embodiments the processor includes an FPGA, an ASIC, or various other electronic components for executing instructions. Some instructions are passed to and executed by the GPU 2420. The GPU 2420 can offload various computations or complement the image processing provided by the processor 2410. Such functionality can be provided using CoreImage's kernel shading language.

The read-only-memory (ROM) 2430 stores static data and instructions that are needed by the processor 2410 and other modules of the computer system. The permanent storage device 2435, on the other hand, is a read-and-write memory device. This device is a non-volatile memory unit that stores instructions and data even when the computer system 2400 is off. Some embodiments of the invention use a mass-storage device (such as a magnetic or optical disk and its corresponding disk drive) as the permanent storage device 2435.

Other embodiments use a removable storage device (such as a floppy disk, flash drive, or CD-ROM) as the permanent storage device. Like the permanent storage device 2435, the system memory 2425 is a read-and-write memory device. However, unlike storage device 2435, the system memory 2425 is a volatile read-and-write memory, such as a random access memory (RAM). The system memory stores some of the instructions and data that the processor needs at runtime. In some embodiments, the sets of instructions and/or data used to implement the invention's processes are stored in the system memory 2425, the permanent storage device 2435, and/or the read-only memory 2430. For example, the various memory units include instructions for processing multimedia items in accordance with some embodiments. From these various memory units, the processor 2420 retrieves instructions to execute and data to process in order to execute the processes of some embodiments.

In addition, the bus 2410 connects to the GPU 2460. The GPU of some embodiments performs various graphics processing functions. These functions may include display functions, rendering, compositing, and/or other functions related to the processing or display the objects within the 3D space of the media-editing application.

The bus 2405 also connects to the input devices 2440 and output devices 2445 The input devices 2440 enable the user to communicate information and select commands to the computer system. The input devices 2440 include alphanumeric keyboards and pointing devices (also called “cursor control devices”). The input devices also include audio input devices (e.g., microphones, MIDI musical instruments, etc.) and video input devices (e.g., video cameras, still cameras, optical scanning devices, etc.). The output devices 2445 include printers, electronic display devices that display still or moving images, and electronic audio devices that play audio generated by the computer system. For instance, these display devices may display a GUI. The output devices include display devices, such as cathode ray tubes (“CRT”), liquid crystal displays (“LCD”), plasma display panels (“PDP”), surface-conduction electron-emitter displays (alternatively referred to as a “surface electron display” or “SED”), etc. The audio devices include a PC's sound card and speakers, a speaker on a cellular phone, a Bluetooth® earpiece, etc. Some or all of these output devices may be wirelessly or optically connected to the computer system.

Finally, as shown in FIG. 24, bus 2405 also couples computer 2400 to a network 2465 through a network adapter (not shown). In this manner, the computer can be a part of a network of computers (such as a local area network (“LAN”), a wide area network (“WAN”), an Intranet, or a network of networks, such as the Internet. For example, the computer 2400 may be coupled to a web server (network 2465) so that a web browser executing on the computer 2400 can interact with the web server as a user interacts with a graphical user interface that operates in the web browser.

As mentioned above, the computer system 2400 may include one or more of a variety of different computer-readable media (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, ultra density optical discs, any other optical or magnetic media, and floppy disks. The computer-readable media may store a computer program that is executable by at least one processor and includes sets of instructions for performing various operations. Examples of hardware devices configured to store and execute sets of instructions include, but are not limited to, ASICs, FPGAs, programmable logic devices (“PLD”), ROM, and RAM devices. Examples of computer programs or computer code include machine code, such as produced by a compiler, and files including higher-level code that are executed by a computer, an electronic component, and/or a microprocessor using an interpreter.

As used in this specification and any claims of this application, the terms “computer”, “server”, “processor”, and “memory” all refer to electronic or other technological devices. These terms exclude people or groups of people. For the purposes of this specification, the terms display or displaying means displaying on an electronic device. As using in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It should be recognized by one of ordinary skill in the art that any or all of the components of computer system 2400 may be used in conjunction with the invention. Moreover, one of ordinary skill in the art will appreciate that any other system configuration may also be used in conjunction with the invention or components of the invention.

While the invention has been described with reference to numerous specific details, one of ordinary skill in the art will recognize that the invention can be embodied in other specific forms without departing from the spirit of the invention. For example, several embodiments were described above by reference to particular media processing applications with particular features and components (e.g., particular display areas). However, one of ordinary skill will realize that other embodiments might be implemented with other types of media processing applications with other types of features and components (e.g., other types of display areas).

Several embodiments are described above by reference to a media processing application that can automatically discover settings of a piece of media content in order to allow a user to view, modify and store media content settings. However, one of ordinary skill will realize that the above-described techniques are used in other embodiments to automatically detect and present settings of other types of content (such as word processing files, database storage structures, software configuration files, etc.).

Moreover, while the examples shown illustrate certain individual modules as separate blocks (e.g., settings discovery tool 2420, the conversion module 2425, etc.), one of ordinary skill in the art would recognize that some embodiments may combine these modules into a single functional block or element. One of ordinary skill in the art would also recognize that some embodiments may divide a particular module into multiple modules.

One of ordinary skill in the art will realize that, while the invention has been described with reference to numerous specific details, the invention can be embodied in other specific forms without departing from the spirit of the invention. For instance, while Apple Mac OS® environment and Apple Compressor® tools are used to create some of these examples, a person of ordinary skill in the art would realize that the invention may be practiced in other operating environments such as Microsoft Windows®, UNIX®, Linux, etc., and other applications such as Autodesk Maya®, and Autodesk 3D Studio Max®, etc. Alternate embodiments may be implemented by using a generic processor to implement the video processing functions instead of using a GPU. One of ordinary skill in the art would understand that the invention is not to be limited by the foregoing illustrative details, but rather is to be defined by the appended claims.

We claim:

1. A computer readable medium storing a media processing application for specifying media settings, the media processing application comprising a graphical user interface (GUI), said GUI comprising:
a) a setting discovery tool for automatically discovering settings of a piece of media content and presenting a plurality of settings including the discovered settings; and
b) a set of tools for allowing a user to modify the presented settings and store the settings.

2. The computer readable medium of claim 1, wherein said setting discovery tool comprises:
a) a setting discovery area for receiving an identification of the media content; and
b) a setting discovery module for automatically discovering the settings of the identified media content.

3. The computer readable medium of claim 2, wherein said setting discovery tool further comprising a monitoring module for monitoring the setting discovery area to determine whether the identification of the media content has been received, and for launching the setting discovery module in response to determining that the identification of the media content has been received.

4. The computer readable medium of claim 2, wherein the setting discovery area is a user interface window for receiving media content through a drag-and-drop operation.

5. The computer readable medium of claim 2, wherein the setting discovery area is further for providing file storage structure browsing operations for identifying the media content in the storage structure.

6. The computer readable medium of claim 1, wherein the presented settings include only the discovered settings.

7. The computer readable medium of claim 1, wherein the setting discovery tool is further for specifying default values for a plurality of settings of the media content for which the setting discovery tool cannot discover a value, and wherein presented settings include the discovered settings and default-value settings.

8. The computer readable medium of claim 1, wherein the set of tools stores the settings in the computer readable medium.

9. A method of defining an application for discovering settings of a piece of content, the method comprising:
defining a settings discovery area for receiving an identification of the piece of content; and
defining a setting discovery module for automatically discovering settings from the identified piece of content and for storing the discovered settings.

10. The method of claim 9 further comprising:
defining a display area for presenting settings including the discovered settings, and
defining a set of tools for allowing modifications to the presented settings and for storing the settings.

11. The method of claim 9 further comprising:
defining a monitoring module for monitoring the setting discovery area to determine whether the identification of the content has been received, and for launching the setting discovery module in response to determining that the identification of the media content has been received.

12. A computer readable medium storing a media processing application for specifying media settings, the media processing application for execution by at least one electronic device, the media processing application comprising sets of instructions for:
receiving an identification of a media file;
automatically discovering settings of the media file without other user input; and
generating another media file using the discovered settings.

13. The computer readable medium of claim 12, wherein the set of instructions for receiving includes a set of instructions for receiving an icon representing the media file through a drag-and-drop operation.

14. The computer readable medium of claim 12 further comprising a set of instructions for:
monitoring the setting discovery area to determine whether the media processing application has received the identification of a media file,
invoking instructions for automatically discovering settings from said media file upon determining that the media processing application has received the identification of the media file.

15. The computer readable medium of claim 12 further comprising a set of instructions for:
displaying the discovered settings for allowing a user to modify said discovered settings.

16. The computer readable medium of claim 12 further comprising a set of instructions for:
specifying a plurality of default values for settings for which a value cannot be automatically discovered, wherein said generating includes generating the other media file using said plurality of default values.

17. The computer readable medium of claim 12 further comprising a set of instructions for:
storing said discovered settings in a data structure.

18. The computer readable medium of claim 12 further comprising a set of instructions for:
determining a metadata setting from metadata in said media file; and
determining at least one discovered setting based on said metadata setting.

19. The computer readable medium of claim 18, wherein said metadata setting includes at least one of a file format, a codec type, a data rate, video frame geometry, and audio channels data.

20. The computer readable medium of claim 18, wherein said set of instructions for determining a metadata setting from metadata in said media file further includes sets of instructions for:
sending a request to a file format application programming interface (API) of said media file to identify said metadata in said media file; and
receiving said metadata from said file format API for determining said metadata setting.

21. The computer readable medium of claim 12 further comprising sets of instructions for:
determining a computed property by analyzing content data in said media file; and
determining at least one discovered setting based on said computed property.

22. The computer readable medium of claim 21, wherein said computed property includes any one of a file size, a frame rate, an aspect ratio, a pixel depth, a spatial quality, a key frame interval, a temporal quality, a data rate, an audio sample rate, a frame resize history, and a frame retiming history.

23. The computer readable medium of claim 12 further comprising sets of instructions for:
determining a settings template based on a file format of said media file, wherein said settings template includes a set of settings parameters for said file format;
analyzing said media file to automatically discover at least one settings value for a first settings parameter of said set of settings parameters;
generating discovered settings that includes said settings value for said corresponding settings parameter; and
storing said discovered settings in a data structure.

24. The computer readable medium of claim 23, wherein said file format includes at least one of a multimedia container format, a video format, or an audio format.

25. The computer readable medium of claim 23, wherein said set of settings parameters includes at least one of encoding parameters, filter parameters, and geometry parameters.

26. The computer readable medium of claim 23 further comprising sets of instructions for:
determining that a settings value was not discovered for at least a second settings parameter of said set of settings parameters;
identifying said settings parameter in a settings display area;
receiving a value as input for said settings parameter; and
adding said value to said discovered settings in said data structure.

27. The computer readable medium of claim 26, wherein said second settings parameter is one of a frame resize history, a frame retiming history, a filter, a frame control, and an audio settings parameter.

28. The computer readable medium of claim 12, wherein the setting discovery tool and the media generation tool are provided from a command-line interface.

29. The computer readable medium of claim 12, wherein the setting discovery tool and the media generation tool are provided from a graphical user interface (GUI).
